(19) United States
(12) Patent Application Publication
(10) Pub. No.: US 2017/0060241 A1
(43) Pub. Date: Mar. 2, 2017

(54) INPUT DEVICE, DISPLAY DEVICE, METHOD OF CONTROLLING INPUT DEVICE, AND PROGRAM

(71) Applicant: FUJITSU TEN LIMITED, Kobe-shi (JP)

(72) Inventors: Shinsuke MATSUMOTO, Kobe-shi (JP); Hitoshi TSUDA, Kobe-shi (JP); Teru SAWADA, Kobe-shi (JP); Yoshihiro NAKAO, Kobe-shi (JP); Masahiro IINO, Kobe-shi (JP)

(73) Assignee: FUJITSU TEN LIMITED, Kobe-shi (JP)

(21) Appl. No.: 15/211,735

(22) Filed: Jul. 15, 2016

(30) Foreign Application Priority Data
Aug. 26, 2015 (JP) 2015-166865
Aug. 31, 2015 (JP) 2015-171009

(51) Int. Cl. G06F 3/01; G06F 3/041; G06F 3/044

(52) U.S. Cl. CPC G06F 3/016; G06F 3/044; G06F 3/0416

(57) ABSTRACT

An input device according to a mode of an embodiment includes a detection unit, at least one vibration element, and a vibration control unit. The detection unit detects a contact position of a user on an operation surface. The vibration element vibrates the operation surface. The vibration control unit controls the vibration element in such a manner that a vibration state of the vibration element becomes a first vibration state when the contact position detected by the detection unit is in a predetermined region and that a vibration state of the vibration element becomes a second vibration state different from the first vibration state when the contact position is outside the predetermined region.

### CROSS-REFERENCE TO RELATED APPLICATIONS

This application is based upon and claims the benefit of priority of the prior Japanese Patent Application No. 2015-166865, filed on Aug. 26, 2015 and Japanese Patent Application No. 2015-171009, filed on Aug. 31, 2015, the entire contents of which are incorporated herein by reference.

### FIELD

The present invention relates to an input device, a display device, a method of controlling the input device, and a program.

### BACKGROUND

Conventionally, an input device to notify a user that an input is received by giving tactile perception to the user has been known. Such an input device notifies a user that an input is received, for example, by generating vibration according to a pressure from the user (see, for example, Japanese Laid-open Patent Publication No. 2013-235614). Also, a device such as a touch-pad in which device an input device is arranged separately from a display device such as a liquid crystal display has been known. In such a device, an operation switch is arranged in a periphery of a touch-pad (see, for example, Japanese Laid-open Patent Publication No. 2013-159273).

However, in a conventional input device that generates vibration according to a pressure from a user, vibration is generated according to a pressure from a user and it is not considered how to give tactile perception, for example, in a case where a user performs operation of moving a contact position on an operation surface. As described, in the conventional input device, there is a problem in a point of improving operability of a user.

### SUMMARY

An input device according to an aspect of the embodiment includes a detection unit, at least one vibration element, and a vibration control unit. The detection unit detects a contact position of a user on an operation surface. The vibration element vibrates the operation surface. The vibration control unit controls the vibration element in such a manner that a vibration state of the vibration element becomes a first vibration state when the contact position detected by the detection unit is in a predetermined region and that the vibration state of the vibration element becomes a second vibration state different from the first vibration state when the contact position is outside the predetermined region.

### BRIEF DESCRIPTION OF DRAWINGS

Deeper recognition of the present invention and an advantage thereof will be easily understood with the following detail description of the invention with reference to attached drawings.

FIG. 1 is a view for describing a method of controlling an input device according to a first embodiment;

FIG. 2 is a block diagram illustrating a configuration of a display device according to the first embodiment;

FIG. 3A is a view for describing an arrangement example of a vibration element according to the first embodiment;

FIG. 3B is a view for describing an arrangement example of a vibration element according to the first embodiment;

FIG. 4A is a view for describing an example of a leading locus set by a locus setting unit according to the first embodiment;

FIG. 4B is a view for describing an example of a leading locus set by the locus setting unit according to the first embodiment;

FIG. 5 is a view for describing a first setting example of a leading locus set by the locus setting unit according to the first embodiment;

FIG. 6A is a view for describing a second setting example of a leading locus set by the locus setting unit according to the first embodiment;

FIG. 6B is a view for describing a second setting example of a leading locus set by the locus setting unit according to the first embodiment;

FIG. 7 is a view for describing a third setting example of a leading locus set by the locus setting unit according to the first embodiment;

FIG. 8 is a flowchart illustrating a processing procedure executed by the input device according to the first embodiment;

FIG. 9 is a view for describing a first modification example of the first embodiment;

FIG. 10 is a view for describing the first modification example of the first embodiment;

FIG. 11 is a view for describing a second modification example of the first embodiment;

FIG. 12A is a view for describing the second modification example of the first embodiment;

FIG. 12B is a view for describing the second modification example of the first embodiment;

FIG. 12C is a view for describing the second modification example of the first embodiment;

FIG. 13 is a view for describing a method of controlling an input device according to a second embodiment;

FIG. 14 is a view illustrating an outline of a display device according to the second embodiment;

FIG. 15 is a block diagram illustrating a configuration of the display device according to the second embodiment;

FIG. 16A is a schematic view for describing an arrangement example of a vibration element and a switch according to the second embodiment;

FIG. 16B is a schematic view for describing the arrangement example of the vibration element and the switch according to the second embodiment;

FIG. 17A is a schematic view for describing a detail of the input device according to the second embodiment;

FIG. 17B is a schematic view for describing a detail of the input device according to the second embodiment;

FIG. 18 is a view illustrating an example of an image displayed on a display unit according to the second embodiment;

FIG. 19 is a flowchart illustrating a processing procedure executed by the input device according to the second embodiment;

FIG. 20 is a view for describing a modification example of the second embodiment;

FIG. 21A is a schematic view illustrating a configuration of an input device according to the modification example of the second embodiment;

FIG. 21B is a schematic view illustrating a configuration of the input device according to the modification example of the second embodiment;

FIG. 22 is a view for describing a divided region according to the modification example of the second embodiment;

FIG. 23 is a view for describing a second adjacent region according to the modification example of the second embodiment;

FIG. 24 is a view for describing a modification example of the second embodiment; and

FIG. 25 is a hardware configuration view illustrating an example of a computer that realizes a function of a display device according to an embodiment.

### DESCRIPTION OF EMBODIMENTS

In the following, embodiments of an input device, a display device, a method of controlling the input device, and a program disclosed in the present application will be described in detail with reference to the attached drawings. Note that the present invention is not limited to the following embodiments.

An input device according to an embodiment includes a detection unit, at least one vibration element, and a vibration control unit. The detection unit detects a contact position of a user on an operation surface. The vibration element vibrates the operation surface. The vibration control unit controls the vibration element in such a manner that a vibration state of the vibration element becomes a first vibration state when the contact position detected by the detection unit is in a predetermined region and that the vibration state becomes a second vibration state different from the first vibration state when the contact position is outside the predetermined region.

### First Embodiment

### 1.1. Method of Controlling Input Device

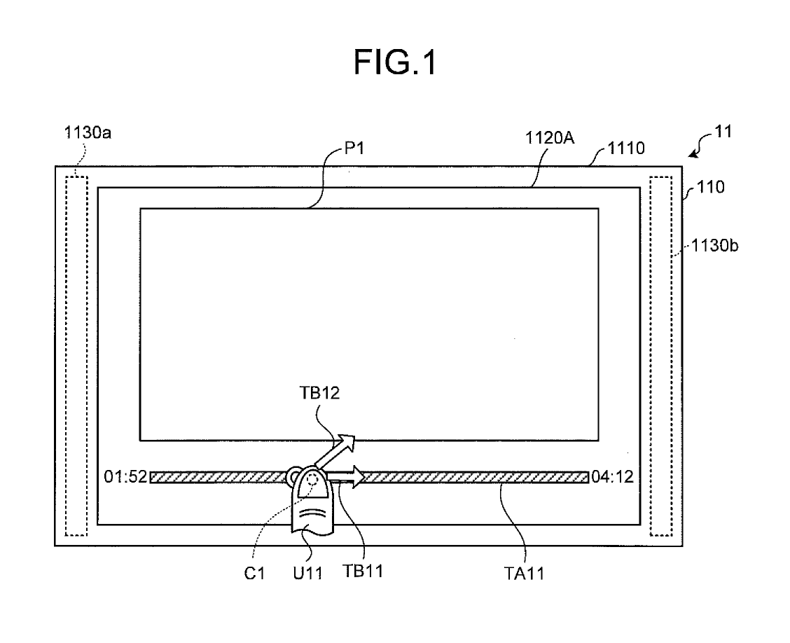

FIG. 1 is a view for describing a method of controlling an input device 110 according to the first embodiment of the present invention. In the present embodiment, a case where an in-vehicle display device 11 installed, for example, in a car navigation system includes the input device 110 will be described.

First, an outline of the display device 11 according to the present embodiment will be described with reference to FIG. 1. Here, it is assumed that the display device 11 includes the input device 110 similarly to a touch panel.

As illustrated in FIG. 1, the display device 11 according to the present embodiment includes the input device 110. The input device 110 includes an operation unit 1110, and vibration elements 1130a and 1130b that vibrate an operation surface 1120A of the operation unit 1110.

The operation unit 1110 is, for example, a transmissive panel having an information input function in an electrostatic capacitance system. A display unit of the display device 11 is arranged on an undersurface of the operation unit 1110. When a user touches the operation surface 1120A with a finger U11 or a pointing device such as a stylus pen, the input device 110 detects a contact position C1 of the user through the operation surface 1120A.

Note that the operation surface 1120A of the operation unit 1110 is arranged in a manner overlapped with a display region of the display unit. An image such as a map for navigation of a vehicle, a television show, a moving image on the Internet, or an image such as a still image is displayed on the display region of the display unit. A user can visually recognize an image displayed on the display region of the display unit through the transmissive operation surface 1120A.

Each of the vibration elements 1130a and 1130b is, for example, a piezoelectric element and vibrates the operation surface 1120A of the operation unit 1110 with a high-frequency wave (for example, in ultrasonic frequency band). For example, when the vibration elements 1130a and 1130b are vibrated in a state in which the finger U11 of the user presses the operation surface 1120A, a state of an air layer between the finger U11 and the operation surface 1120A changes and friction force changes. When the finger U11 is moved in such a state, it is possible to give the finger U11 tactile perception corresponding to the changed friction force. Also, by changing a vibration state of the vibration elements 1130a and 1130b, it is possible to change magnitude of the friction force between the finger U11 and the operation surface 1120A and to change the tactile perception given to finger U11.

As described, the input device 110 according to the present embodiment is an input device to give a user tactile perception by vibrating the operation surface 1120A with the vibration elements 1130a and 1130b. In the following, a method of controlling such an input device 110 will be described.

Here, in the display device 11 illustrated in FIG. 1, for example, a moving image P1 is played and a seek bar displayed under the moving image P1 is displayed. Here, the seek bar is a graphical user interface (GUI) part to display a played position in the moving image P1. For example, in FIG. 1, it is possible to change a played position in the moving image P1 by sliding the seek bar to a right/left side.

The input device 110 sets a predetermined leading locus TA11 (hereinafter, also referred to as leading locus TA1) such as a seek bar according to an image to be an object of operation by a user. In the example in FIG. 1, the leading locus TA11 is a locus set along the seek bar.

The input device 110 detects a contact position C1 of the user on the operation surface 1120A. The input device 110 controls the vibration elements 1130a and 1130b according to the detected contact position C1. For example, as indicated by an arrow TB11 in FIG. 1, when the finger U11 of the user moves to the right on the seek bar, that is, when the contact position C1 of the user on the operation surface 1120A moves along the leading locus TA11, the input device 110 controls the vibration elements 1130a and 1130b in such a manner that a vibration state of the vibration elements 1130a and 1130b becomes a first state.

Also, for example, as indicated by an arrow TB12 in FIG. 1, when the finger U11 of the user moves to an upper right side from the seek bar, that is, when the contact position C1 of the user on the operation surface 1120A moves in a manner deviated from the leading locus TA11, the input device 110 controls the vibration elements 1130a and 1130b in such a manner that a vibration state of the vibration elements 1130a and 1130b becomes a second state.

Here, when the vibration state of the vibration elements 1130a and 1130b is the first state, it is indicated that the vibration elements 1130a and 1130b vibrate with a high-frequency wave, for example. When the vibration elements 1130a and 1130b vibrate with the high-frequency wave, friction force between the operation surface 1120A and a contact surface of the user (such as finger U11) is decreased and the finger U11 of the user moves smoothly on the operation surface 1120A. That is, by changing the vibration state of the vibration elements 1130a and 1130b into the first state, the input device 110 can give the finger U11 of the user slippery and smooth tactile perception, for example.

Also, when the vibration state of the vibration elements 1130a and 1130b is in the second state, a state in which the vibration elements 1130a and 1130b are not vibrated is indicated, for example. When the vibration elements 1130a and 1130b are not vibrated, predetermined friction force between the operation surface 1120A and the contact surface of the user (such as finger U11) is generated and the finger U11 of the user does not move smoothly on the operation surface 1120A compared to the first state. That is, by changing the vibration state of the vibration elements 1130a and 1130b into the second state, the input device 110 can give unsmooth tactile perception to the finger U11 of the user, for example.

As described above, in the method of controlling the input device 110 according to the present embodiment, when the contact position C1 of the user on the operation surface 1120A moves along the leading locus TA11, the vibration state of the vibration elements 1130a and 1130b is set to the first state and smooth tactile perception is given to the finger U11 of the user. Also, when a movement is made in a manner deviated from the leading locus TA11, the vibration state is set to the second state and unsmooth tactile perception is given.

Accordingly, a finger moves smoothly along the leading locus TA11 on the operation surface and it becomes easy for the user to move the finger U11 along the leading locus TA11. Moreover, since it becomes easier to realize a deviation from the leading locus TA11, for example, in the case of FIG. 1, it becomes possible to easily operate the seek bar. As described, according to the control method according to the present embodiment, it is possible to improve operability of a user.

For example, when the display device 11 including the input device 110 is installed in a vehicle, a driver who is a user needs to pay attention to a surrounding condition and may not be able to look at the display device 11 carefully during operation. Even in such a case, when a vibration state of the vibration elements 1130a and 1130b is changed to make it easy to move the finger U11 along the leading locus TA11 and to realize a deviation from the leading locus TA11, it becomes easy for the user to operate the display device 11.

Note that here, a case where the display device 11 is a display device of a navigation system installed in a vehicle has been described. However, this is not the limitation. For example, the display device 11 may be a smartphone, a tablet terminal, or a personal computer.

Also, here, a case where the input device 110 includes a display unit 120 such as a case of a touch panel has been described. However, this is not the limitation. For example, the input device 110 may be a device, such as a touch-pad, that does not include a display unit and that receives input operation according to a contact position C1 of a user. In the following, the display device 11 including the input device 110 controlled by the control method will be further described.

### 1.2. Display Device 11

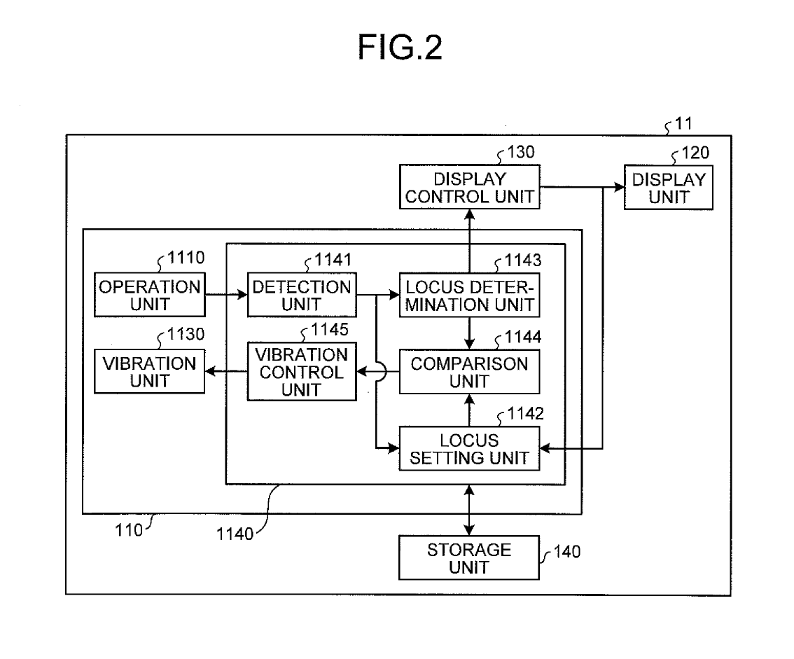

FIG. 2 is a block diagram illustrating a configuration of the display device 11 according to the present embodiment. The display device 11 includes the input device 110, the display unit 120, a display control unit 130, and a storage unit 140.

1.2.1. Display Unit 120

The display unit 120 is, for example, a liquid crystal display and presents an image output by the display control unit 130 to a user.

1.2.2. Display Control Unit 130

The display control unit 130 generates an image to be displayed on the display unit 120, for example, based on input operation received by the input device 110 from a user. The display control unit 130 outputs the generated image to the display unit 120. The display control unit 130 controls the display unit 120 to present the image to a user.

1.2.3. Input Device 110

The input device 110 is an information input device such as a touch panel or a touch-pad. The input device 110 receives input operation by a user on the display device 11 and outputs, to the display control unit 130, a signal corresponding to the input operation by the user. The input device 110 includes an operation unit 1110, a vibration unit 1130, and a control unit 1140.

1.2.3.1. Operation Unit 1110

The operation unit 1110 is, for example, a tabular sensor of a touch-pad or a touch panel. The operation unit 1110 includes the operation surface 1120A to receive input operation by a user. When the user touches the operation surface 1120A, the operation unit 1110 outputs a sensor value corresponding to the contact position C1 of the user to the control unit 1140.

For example, when the input device 110 is a touch panel having a display function, the operation unit 1110 has a function of the display unit 120. That is, it is possible to configure the operation unit 1110 and the display unit 120 as one device. In this case, for example, the operation surface 1120A becomes a display surface of the display unit 120.

1.2.3.2. Vibration Unit 1130

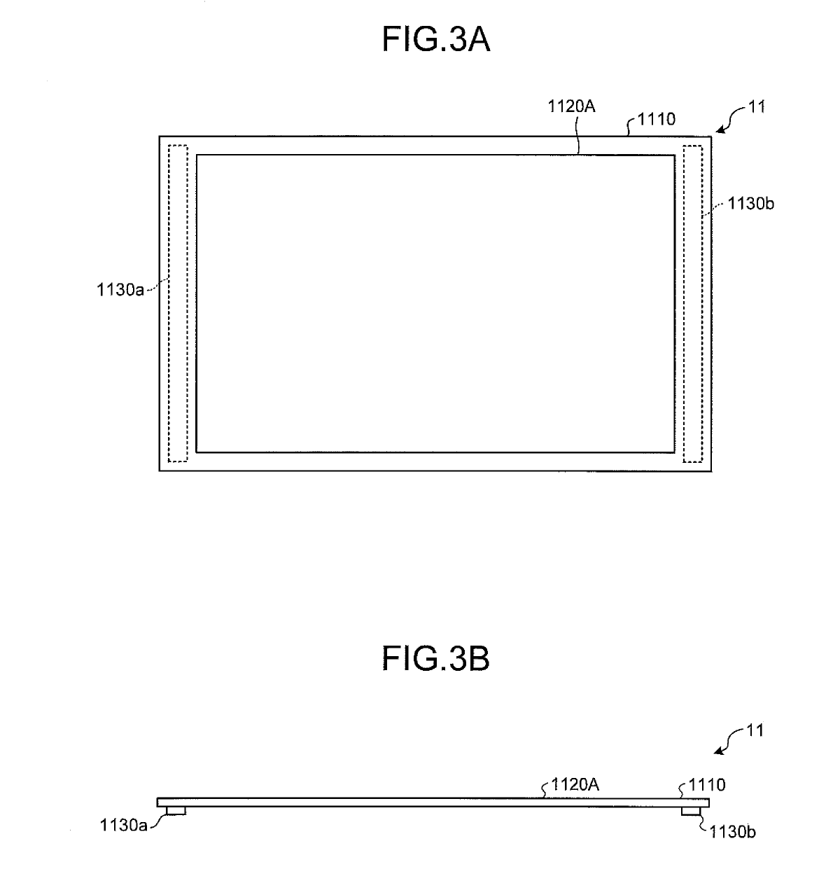

The vibration unit 1130 includes at least one vibration elements. In an example illustrated in FIGS. 3A and 3B, the vibration unit 1130 includes two vibration elements 1130a and 1130b. Each of the vibration elements 1130a and 1130b is a piezoelectric actuator such as a piezoelectric element (piezo element). By being extended/contracted according to a voltage signal given by the control unit 1140, the vibration elements 1130a and 1130b vibrate the operation unit 1110. Each of the vibration elements 1130a and 1130b are arranged at a position that is not visually recognized by a user and that is, for example, an end of the operation unit 1110 in a manner in contact with the operation unit 1110.

In the example of FIGS. 3A and 3B, the vibration elements 1130a and 1130b are arranged in regions that are on right and left outer sides of the operation surface 1120A and that are on a surface facing the operation surface 1120A of the operation unit 1110. Note that FIGS. 3A and 3B are view for describing an arrangement example of the vibration elements 1130a and 1130b. A configuration element unnecessary for the description is not illustrated.

Note that the number and an arrangement of vibration elements 1130a and 1130b illustrated in FIGS. 3A and 3B are just an example and this is not the limitation. For example, the operation surface 1120A may be vibrated with one vibration element. As described, although the number and an arrangement of vibration elements 1130a and 1130b are arbitrary, the number and the arrangement are preferably determined in such a manner that a whole operation surface 1120A is vibrated uniformly.

Also, here, a case where a piezoelectric element is used as each of the vibration elements 1130a and 1130b has been described. However, this is not the limitation. For example, an element only needs to be what vibrates the operation surface 1120A in an ultrasonic frequency band.

1.2.3.3. Control Unit 1140

The control unit 1140 controls each unit of the input device 110. Also, the control unit 1140 outputs, to the display control unit 130, a signal corresponding to input operation received through the operation unit 1110. The control unit 1140 includes a detection unit 1141, a locus setting unit 1142, a locus determination unit 1143, a comparison unit 1144, and a vibration control unit 1145.

1.2.3.3.1. Detection Unit 1141

The detection unit 1141 detects the contact position C1 of the user on the operation surface 1120A based on a sensor value output by the operation unit 1110. For example, since the detection unit 1141 detects the contact position C1 of the user in a predetermined cycle, even when the finger U11 of the user moves on the operation surface 1120A and the contact position C1 changes, the detection unit 1141 can detect the contact position C1 along with the change. The detection unit 1141 outputs, to the locus determination unit 1143, the contact position C1 of the user which position is a result of the detection.

1.2.3.3.2. Locus Setting Unit 1142

The locus setting unit 1142 sets a leading locus TA1 corresponding to input operation performed by a user. Here, the leading locus TA1 is, for example, a locus on which the finger U11 of the user preferably moves on the operation surface 1120A in a case where the user performs predetermined input operation.

The locus setting unit 1142 sets the leading locus TA1, for example, based on an image displayed on the display unit 120 by the display control unit 130 or the contact position C1 of the user on the operation surface 1120A which position is detected by the detection unit 1141. Also, the locus setting unit 1142 sets, for example, a starting point and an end point of the leading locus TA1 as the leading locus TA1.

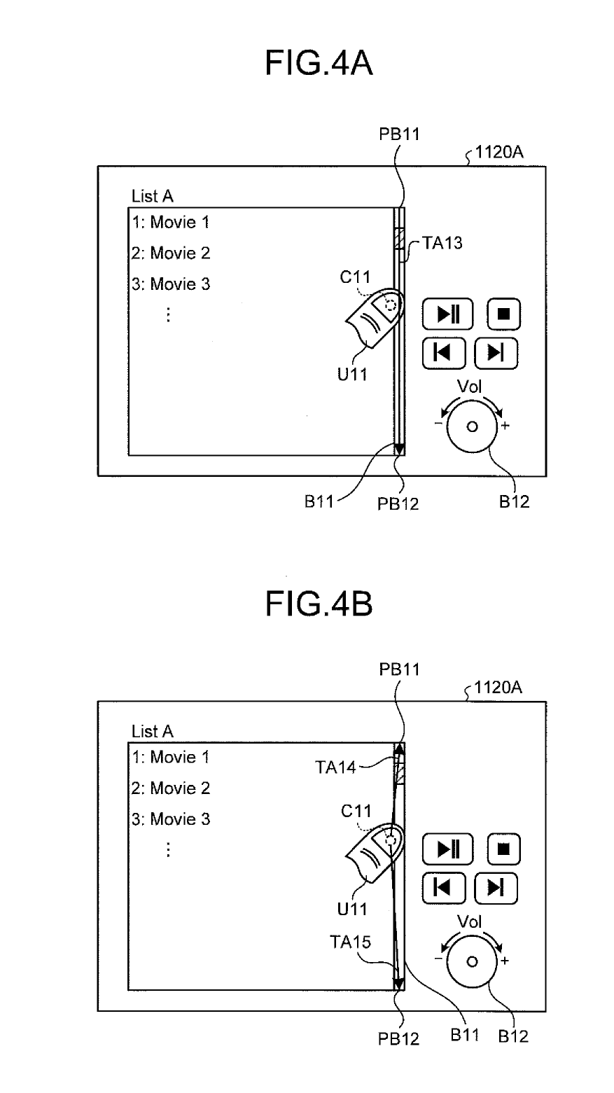

An example of the leading locus TA1 set by the locus setting unit 1142 will be described with reference to FIGS. 4A and 4B. Note that in FIGS. 4A and 4B, in order to simplify the description, a configuration element unnecessary for the description is not illustrated. In FIGS. 4A and 4B, for example, a playlist of a moving image is displayed on the display unit 120. In a case of selecting a moving image to be played from the playlist, a user performs scrolling operation to scroll the playlist. When the user performs the scrolling operation, the finger U11 of the user preferably moves on a scroll bar B11 displayed on the display unit 120. Thus, the locus setting unit 1142 sets a leading locus TA1 along the scroll bar B11, for example.

For example, in an example illustrated in FIG. 4A, the locus setting unit 1142 sets a leading locus TA13 with one end PB11 of the scroll bar B11 as a starting point and the other end PB12 as an end point. In such a manner, the locus setting unit 1142 sets the leading locus TA13 according to the scroll bar B11 that is an object to be displayed on the display unit 120. That is, the locus setting unit 1142 sets the leading locus TA13 according to at least one of an arrangement and a size of an object to be displayed. The set leading locus TA13 is output to the comparison unit 1144.

In FIG. 4A, a case where there is one scroll bar B11 to be displayed has been described. However, this is not the limitation. For example, when a plurality of scroll bars is displayed on the display unit 120, a leading locus TA1 is set for each of the plurality of scroll bars. In such a manner, the locus setting unit 1142 sets the leading locus TA13 according to at least one of the number, an arrangement, and a size of objects to be displayed.

Alternatively, as illustrated in FIG. 4B, the locus setting unit 1142 may set a first leading locus TA14 with a contact position C11 of a user as a starting point and a position corresponding to input operation such as the one end PB11 of the scroll bar B11 as an end point based on a result of the detection by the detection unit 1141. Moreover, for example, a second leading locus TA15 with a contact position C11 of a user as a starting point and the other end PB12 of the scroll bar B11 as an end point may be set. In such a manner, the locus setting unit 1142 may set a plurality of leading loci TA1.

In such a manner, the locus setting unit 1142 dynamically sets the leading locus TA1 based on an image to be displayed on the display unit 120 or a contact position C1 of a user on the operation surface 1120A. Accordingly, it is possible to dynamically set a leading locus TA1 corresponding to each kind of input operation by a user.

Also, here, a case where the locus setting unit 1142 sets a starting point and an end point of the leading locus TA1, that is, a case where the leading locus TA1 is a straight line has been described. However, the leading locus TA1 is not limited to this. For example, as illustrated in FIGS. 4A and 4B, there is a case where a contact position C1 moves on a curved line such as a case where input operation is performed by tracing of an outer periphery of a circular button B12 such as a dial. In this case, for example, the locus setting unit 1142 may set a leading locus TA1 by setting a plurality of points including a starting point and an end point and connecting these points with a line segment. Alternatively, the locus setting unit 1142 may set a leading locus TA1 in a curved line such as an arc or a Bezier curve that connects a plurality of points.

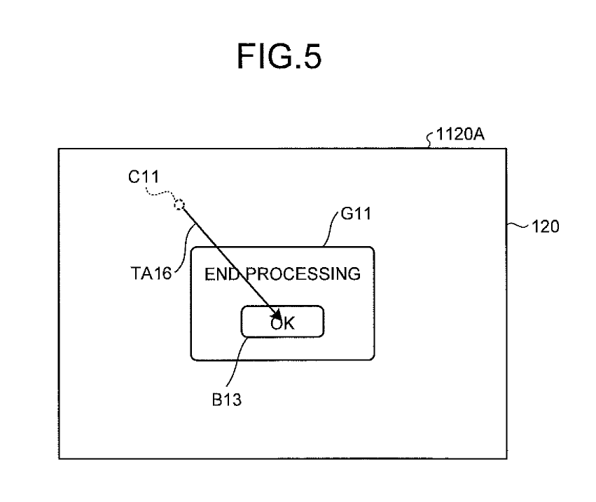

Also, a leading locus TA1 set by the locus setting unit 1142 is not limited to a line segment. For example, the leading locus TA1 may be a belt-shaped locus having a predetermined width. In this case, for example, the locus setting unit 1142 sets a width W1 of the leading locus TA1 in addition to a starting point and an end point of the leading locus TA1. Alternatively, the locus setting unit 1142 may set a closed section that connects a plurality of points and set the closed section as a leading locus TA1. Note that a different example of a leading locus TA1 set by the locus setting unit 1142 will be described later with reference to FIG. 5 to FIG. 7.

1.2.3.3.3. Locus Determination Unit 1143

According to a contact position C1 of a user which position is detected by the detection unit 1141, the locus determination unit 1143 determines a movement locus of the contact position C1. For example, the locus determination unit 1143 determines, as a movement locus, a line that connects a contact position C1n (n is natural number) detected by the detection unit 1141 at current time Tin and a contact position C1(n−1) detected at time T1(n−1) that precedes the time Tin for one cycle. Here, the locus determination unit 1143 outputs the determined movement locus to the comparison unit 1144.

Note that a movement locus determined by the locus determination unit 1143 is based on a result of the detection by the detection unit 1141 at the time T1(n−1) and T1n. However, this is not the limitation. For example, the locus determination unit 1143 may determine, as a movement locus, a line that connects contact positions C1(n−m) to C1n detected in a period from time T1(n−m) to time Tin.

Alternatively, for example, a contact position C1(n+1) at the following time T1(n+1) may be predicted based on at least one of contact positions C11 to C1n detected in a period from time T11 at which detection is started to time Tin and a line segment that connects the predicted contact position C1(n+1) and the contact position C1n detected by the detection unit 1141 may be determined as a movement locus.

1.2.3.3.4. Comparison Unit 1144

The comparison unit 1144 compares the leading locus TA1 set by the locus setting unit 1142 with the movement locus determined by the locus determination unit 1143. For example, the comparison unit 1144 calculates a distance D11 between a starting point of the movement locus and the leading locus TA1 and a distance D12 between an end point of the movement locus and the leading locus TA1. Then, the comparison unit 1144 outputs a result of the calculation to the vibration control unit 1145 as a result of the comparison.

Alternatively, for example, when a leading locus TA1 is a belt-shaped locus having a predetermined width W1, the comparison unit 1144 may determine whether a starting point and an end point of a movement locus is included in the leading locus TA1 and may output a result of the determination to the vibration control unit 1145 as a result of the calculation.

1.2.3.3.5. Vibration Control Unit 1145

According to a result of the comparison by the comparison unit 1144, the vibration control unit 1145 changes a vibration state of the vibration elements 1130a and 1130b of the vibration unit 1130 into a first vibration state when a movement locus is along a leading locus TA1 and changes a vibration state of the vibration elements 1130a and 1130b into a second vibration state when a movement locus deviates from the leading locus TA1.

For example, when the vibration control unit 1145 receives, from the comparison unit 1144, distances D11 and D12 from a starting point and an end point of the movement locus to the leading locus TA1 as a result of the comparison, in a case where the distances D11 and D12 are shorter than a predetermined threshold, the vibration control unit 1145 determines that the movement locus is along the leading locus TA1. Also, when at least one of the distances D11 and D12 is equal to or longer than the predetermined threshold, the vibration control unit 1145 determines that the movement locus is deviated from the leading locus TAT.

Alternatively, when the comparison unit 1144 determines whether a starting point and an end point of a movement locus is included in the leading locus TA1, the vibration control unit 1145 determines that the movement locus is along the leading locus TA1 in a case where the starting point and the end point of the movement locus are included in the leading locus TA1 and that the movement locus is deviated in a case where these points are not included.

In a case of changing a vibration state of the vibration elements 1130a and 1130b into the first vibration state, the vibration control unit 1145, for example, generates a voltage signal, with which the vibration elements 1130a and 1130b are vibrated with a high-frequency wave (for example, in ultrasonic frequency band), and outputs the signal to the vibration unit 1130. Accordingly, since the vibration elements 1130a and 1130b and the operation unit 1110 are vibrated with the high-frequency wave, friction force between the operation surface 1120A and a contact surface of a user (such as finger U11) is decreased and the finger U11 of the user moves smoothly on the operation surface 1120A.

Also, in a case of changing a vibration state of the vibration elements 1130a and 1130b into the second vibration state, the vibration control unit 1145, for example, generates a voltage signal, with which the vibration elements 1130a and 1130b are not vibrated, and outputs the signal to the vibration unit 1130. Accordingly, the vibration elements 1130a and 1130b are brought into a non-vibration state and predetermined friction force is generated between the operation surface 1120A and the contact surface of the user (such as finger U11). Thus, it becomes difficult for the finger U11 of the user to move smoothly on the operation surface 1120A compared to the first state.

Accordingly, it becomes easy for the user to move the finger U11 along the leading locus TA1 and to perform input operation on the leading locus TA1. In such a manner, by giving feedback to tactile perception of a user whether a contact position C of the user moves along the leading locus TA1, it is possible to improve operability of the user.

1.2.4. Storage Unit 140

For example, the storage unit 140 stores the leading locus TA1 set by the locus setting unit 1142 while associating the locus with input operation performed by a user. Also, the storage unit 140 stores a history of the contact position C1 of the user which position is detected by the detection unit 1141. In such a manner, the storage unit 140 stores information necessary for processing performed by each unit of the input device 110 and a result of processing.

Also, the storage unit 140 stores an image to be displayed on the display unit 120 by the display control unit 130. The storage unit 140 is a semiconductor memory element such as a random access memory (RAM) or a flash memory, or a storage device such as a hard disk or an optical disk.

### 1.3. Setting Example of Leading Locus TA1

Next, an example of a leading locus TA1 set by the locus setting unit 1142 will be described with reference to FIG. 5 to FIG. 7.

### 1.3.1. First Setting Example

FIG. 5 is a view for describing a first setting example of a leading locus TA1 set by the locus setting unit 1142. In the example illustrated in FIG. 5, it is assumed that an image G11 and a button B13, which present information to a user, such as a dialog box is displayed on the display unit 120 and that the input device 110 waits for reception of operation of pressing the button B13 performed by the user through the operation surface 1120A.

Here, it is assumed that the user presses the operation surface 1120A and the detection unit 1141 detects the contact position C11 of the user. Here, the locus setting unit 1142 sets a leading locus TA16 with the contact position C11 as a starting point and a position where input operation is received (here, it is button B13 and will be hereinafter referred to as target position of input operation) as an end point. Note that in FIG. 5, it is assumed that a center of the button B13 is a target position of input operation. However, this is not the limitation. For example, a place, which is the closest from the contact position C11, in the button B13 may be a target position.

As described above, in a case where the display device 11 including the input device 110 is installed in a vehicle, it may not possible to look at the display device 11 carefully during operation. In such a case, for example, even when the button B13 is displayed on the display unit 120, the user may press a place different from the button B13. Alternatively, for example, when a display of the button B13 is small, a user may press a place different from the button B13 when trying to press the button B13.

In such a manner, even in a case where the user presses the place different from the button B13, when the locus setting unit 1142 sets the leading locus TA16 from the pressed position C11 to the button B13 that is the target position, it is possible to guide the user to the button B13, for example, with slippery tactile perception and it is possible for the user to easily perform input operation of pressing the button B13. Thus, it is possible to improve operability of a user.

Here, for example, it is assumed that the user moves the finger U11 along the leading locus TA16 and the contact position C11 reaches the button B13 that is the target position. Here, for example, the vibration control unit 1145 may give a user tactile perception as if there is a protruded surface at the target position on the operation surface 1120A by controlling the vibration unit 1130 in such a manner that friction force of the operation surface 1120A is increased for a predetermined period. Note that the vibration control unit 1145 receives a result of the detection of the contact position C11 of the user from the detection unit 1141 and determines whether the contact position C11 reaches the target position.

Accordingly, the vibration control unit 1145 can give the user tactile perception of getting over a button B13 or a boundary of the button B13 and can notify the user that the button B13 that is the target position is reached.

Note that a method of notifying that the target position is reached is not limited to the above-described notification by tactile perception. For example, sound may be output for notification when the target position is reached. Here, for example, sound may be output through a speaker (not illustrated). Alternatively, the vibration elements 1130a and 1130b of the vibration unit 1130 may be vibrated in an audible area by the vibration control unit 1145 and tactile sensation may be changed by a change in vibration or sound may be output by vibration of the operation surface in an audible frequency. Alternatively, the vibration elements 1130a and 1130b of the vibration unit 1130 may be controlled in such a manner that the input device 110 itself is vibrated and vibration may be directly transmitted to the user.

### 1.3.2. Second Setting Example of Leading Locus TA1

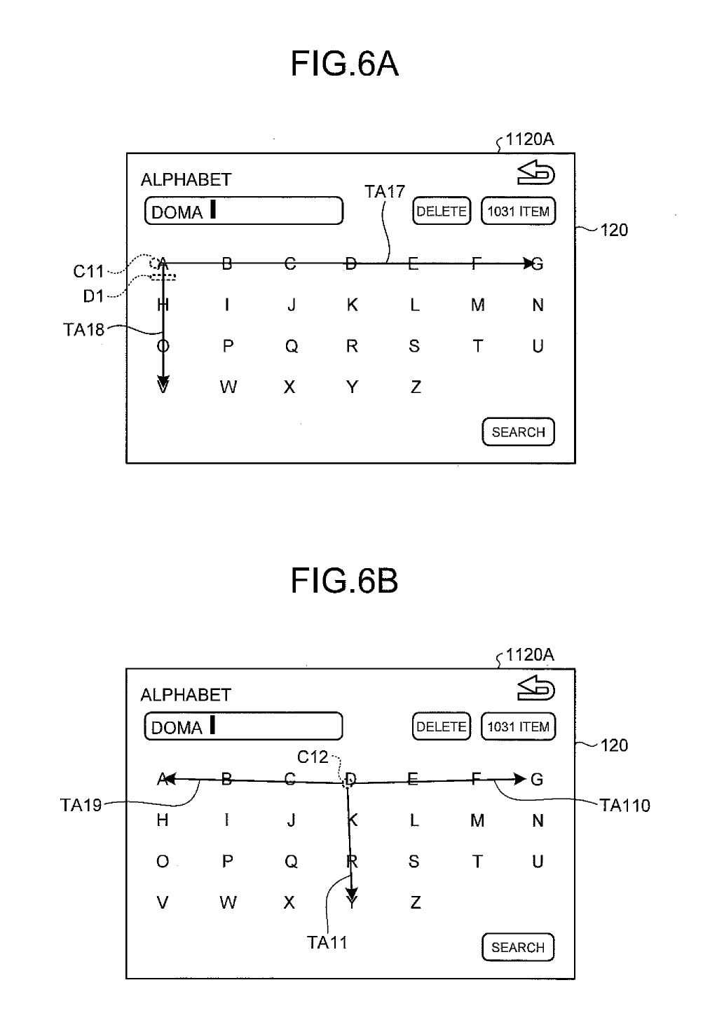

FIGS. 6A and 6B is a view for describing a second setting example of a leading locus TA1 set by the locus setting unit 1142. In the example illustrated in FIGS. 6A and 6B, alphabets that are objects to be displayed are displayed in order of ABC on the display unit 120 and the input device 110 receives character input operation when a user selects an alphabet that is an object to be displayed.

Here, when the finger U11 of the user is released from the operation surface 1120A, the input device 110 receives input operation of an alphabet to be displayed which operation is performed by the user. That is, when the finger U11 of the user moves away from the operation surface 1120A and the detection unit 1141 no longer detects the contact position C1 of the user, the input device 110 receives input operation of a character corresponding to the last contact position C1 detected by the detection unit 1141. Here, it is assumed that each character, which is an object to be displayed, includes a predetermined display region and is displayed on the display region. The display regions of characters are arranged in the display unit 120 without being overlapped with each other. It is assumed that the input device 110 receives input operation of a character in a display region including the contact position C1 of the user.

Thus, for example, the user performs operation of moving the finger U11 on the operation surface 1120A in a state in which the finger is in contact with the operation surface 1120A and releasing the finger U11 on a character to be input on the operation surface 1120A. Accordingly, the user can input a character corresponding to the contact position C1 on which the finger U11 is placed before being released from the operation surface 1120A.

In FIGS. 6A and 6B, in a case where the user performs the above character input operation, the locus setting unit 1142 sets the leading locus TA1 according to the contact position C1 of the user, whereby it becomes easy for the user to perform the character input operation.

In a case where the user performs character input operation based on a list of alphabets, for example, a method of looking for a character to be input by looking for a corresponding row in a plurality of rows such as a low starting from “A” and a row starting from “H” and by looking for a corresponding character in alphabets is considered.

Thus, for example, as illustrated in FIG. 6A, the locus setting unit 1142 according to the present embodiment sets a first leading locus TA17 extended in a horizontal direction in the drawing from the contact position C11 of the user which position is detected by the detection unit 1141 and a second leading locus TA18 extended in a vertical direction in the drawing from the contact position C11.

For example, as illustrated in FIG. 6A, when the contact position C11 of the user is placed in a display region of a character “A,” the locus setting unit 1142 sets a first leading locus TA17 with the contact position C11 as a starting point and a display region of a character placed at the end of characters in the row starting from “A” (“G” in FIG. 6A) as an end point. Also, the locus setting unit 1142 sets a second leading locus TA18 with the contact position C11 as a starting point and a display region of a character placed at the end of characters in a column starting from “A” (“V” in FIG. 6A) as an end point.

Then, a case where the finger U11 of the user moves on the operation surface 1120A and the contact position moves from “C11” to “C12” will be described. Here, for example, as illustrated in FIG. 6B, the locus setting unit 1142 sets first and second leading loci TA19 and TA110 extended in a horizontal direction in the drawing from the contact position C12 of the user which position is detected by the detection unit 1141 and a third leading locus TA111 extended in a vertical direction in the drawing from the contact position C12.

For example, as illustrated in FIG. 6B, when the contact position C12 of the user is placed in a display region of a character “D,” the locus setting unit 1142 sets a first leading locus TA19 with the contact position C12 as a starting point and a display region of a character placed at the left end of characters in the row starting from “A” (“A” in FIG. 6B) as an end point. Also, the locus setting unit 1142 sets a second leading locus TA110 with the contact position C12 as a starting point and a display region of a character placed at the right end of characters in the row starting from “A” (“G” in FIG. 6B) as an end point. The locus setting unit 1142 sets a third leading locus TA111 with the contact position C12 as a starting point and a display region of a character placed at the end of characters in the column starting from “D” (“Y” in FIG. 6B) as an end point.

In such a manner, when the contact position C1 of the user moves, the locus setting unit 1142 changes the leading locus TA1. Accordingly, the locus setting unit 1142 can dynamically set the leading locus TA1 according to the contact position C1 of the user and to set an appropriate leading locus TAT even when the contact position C1 of the user moves. Thus, the user can easily perform input operation along an appropriate leading locus TA1 and operability of the user is improved.

Note that here, the contact positions C11 and C12 of the user are set as starting points of the leading locus TA1. However, for example, display regions including the contact positions C11 and C12 of the user may be set as starting points of the leading locus TA1.

Here, for example, when the contact position C1 moves to a display region of a different character along the leading locus TA1, the vibration control unit 1145 may notify a movement to a display region of a different character to a user by giving the user tactile perception of getting over the display region.

With reference to FIG. 6A, for example, a case where the contact position C11 moves from a display region of “A” to a display region of “H” along the leading locus TA18 will be described. Here, the vibration control unit 1145 changes a vibration state of a vibration unit 1130 in a boundary region D1 between the display region of “A” and the display region of “H” into a state different from the first vibration state. For example, when the contact position C11 is placed in the boundary region D1, the vibration control unit 1145 controls the vibration unit 1130 in such a manner that friction force between the operation surface 1120A and a contact surface of the user (such as finger U11) becomes greater than that in the first vibration state.

Accordingly, when the contact position C11 moves in the boundary region D1, tactile perception with which the finger U11 does not move smoothly compared to a case where a movement is in the display region of “A” and the display region of “H” can be given to the user and to give the user tactile perception as if a protruded surface is generated in the boundary region D1, that is, the boundary region D1 is gotten over. Note that a method of notifying a movement of a display region is not limited to the above-described notification by tactile perception. For example, sound may be output for notification when there is a movement from a display region.

Note that tactile perception that is given when there is a movement in the boundary region D1 is tactile perception that is less smooth than a case where there is a movement along the leading locus TA1 and that is smoother than a case where there is a deviation from the leading locus TA1, for example. That is, for example, friction force between the user and the operation surface 1120A is the lowest in a case where a movement is along the leading locus TA1, is the highest in a case where there is a deviation from the leading locus TA1, and is in the middle in a case where there is a movement in the boundary region D1. Accordingly, the finger U11 moves smoothly in order of a case where there is a movement along the leading locus TA1, a case where there is a movement in the boundary region D1, and a case where there is a deviation from the leading locus TA1. That is, it becomes easy for the user to move the finger U11 along the leading locus TA1 without a deviation from the leading locus TA1 and to recognize that there is a movement in a display region. Note that in a case where there is a movement in the boundary region D1, it is only necessary to present to a user that there is a movement in a display region. For example, the vibration unit 1130 may be vibrated with a low-frequency wave.

Also, as illustrated in FIGS. 6A and 6B, for example, when the input device 110 receives character input operation for an institution search in a navigation system, there is a case where a character that is received in the input operation is limited depending on the input device 110. For example, such an input device 110 only receives input operation of a character included in a candidate in a search result. Thus, when the number of candidates in the search result is narrowed down by an input of a character by a user, the number of characters included in the candidates is decreased and a character input operation of which is not received by the input device 110 is generated.

Here, for example, the display device 11 changes a display color of a character an input of which is not received into a color close to a background color and presents to a user that input operation of a predetermined character is not to be received. Also, the locus setting unit 1142 of the input device 110 sets a leading locus TA1 with the contact position C11 of the user as a starting point and a display region of a character, an input operation of which is received, as an end point. Accordingly, it becomes possible to guide the contact position C11 of the user to a character input operation of which is received.

Note that when the number of characters input operation of which is received by the input device 110 is equal to or larger than a predetermined threshold, as illustrated in FIGS. 6A and 6B, a leading locus TA1 that is extended in a vertical or horizontal direction from the contact position C11 may be set and when the number is smaller than the predetermined threshold, a leading locus TA1 with a character, input operation of which is received, as an end point may be set.

Also, for example, when the contact position C1 is included in the display region of “A,” the vibration control unit 1145 may control the vibration unit 1130 into a vibration state different from the first and second vibration states. For example, when the finger U11 of the user is in contact with the display region of “A,” friction force is made lower than that in the first vibration state. Alternatively, rough tactile perception is given to the user by switching of magnitude of the friction force in a predetermined cycle. For example, in a case where a character input is performed by utilization of an alphabet list, “A” is set as a reference position (home position) of the character input operation. Here, since specific tactile perception is given to the user when the finger U11 is placed on the reference position, the user can check a position of the finger U11 on the operation surface 1120A even when the user cannot look at the display unit 120 carefully.

In such a manner, at a specific position on the operation surface 1120A, a vibration state is brought into a state different from the first and second vibration states, that is, specific tactile perception is given to the user. Accordingly, it becomes possible for the user to easily recognize a specific position on an operation surface 1120A.

Note that here, a case where alphabets are displayed in order of ABC on the display unit 120 has been described. However, this is not the limitation. For example, a layout of the alphabets may be a QWERTY layout. In this case, for example, “F” and “J” become the above-described reference positions.

### 1.3.3. Third Setting Example of Leading Locus TA1

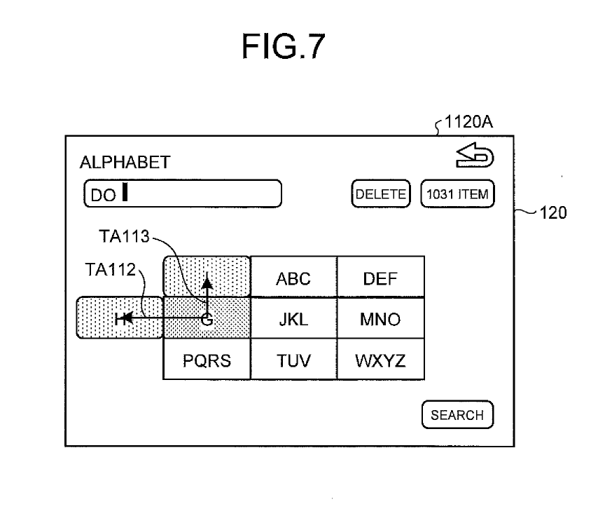

FIG. 7 is a view for describing a third setting example of a leading locus TA1 set by the locus setting unit 1142. In the example illustrated in FIG. 7, alphabet characters that are objects to be displayed are displayed on the display unit 120 and the input device 110 receives character input operation when a user selects an alphabet that is an object to be displayed. Note that here, similarly to the case of FIGS. 6A and 6B, when the finger U11 of the user is released from the operation surface 1120A, the input device 110 receives input operation of a alphabet character to be displayed which input is performed by the user.

In the example in FIG. 7, the user selects a plurality of characters to be input, for example, by touching characters displayed on the display unit 120 with the finger U11. Then, the user selects a character to be input by moving the finger U11 to the character to be input in a state in which the finger U11 selects the plurality of characters to be input, that is, in a state in which the finger U11 is in contact with the operation surface 1120A. In such a manner, in FIG. 7, character input operation is performed by a so-called “flick input.”

In this case, when the user selects a plurality of characters to be input, the display unit 20 displays a plurality of input candidate characters on upper/lower/right/left sides of a selected character. For example, in FIG. 7, when the user touches “GHI,” a plurality of characters “G, H, and I” are selected. The display unit 120 receives the selectin and displays input candidate characters “H” and “I” around the character “G.”

Here, in a case where the display unit 120 displays the input candidate characters “H” and “I” as objects to be displayed, the locus setting unit 1142 sets leading loci TA112 and TA113 from the character “G” selected by the user to the input candidate characters “H” and “I.”

Accordingly, it becomes easy for the user to move the finger U11 along the leading loci TA112 and TA113 and to select an input candidate character. In such a manner, even in a case where the user performs the flick input, operability of the user can be improved.

### 1.4. Control Processing

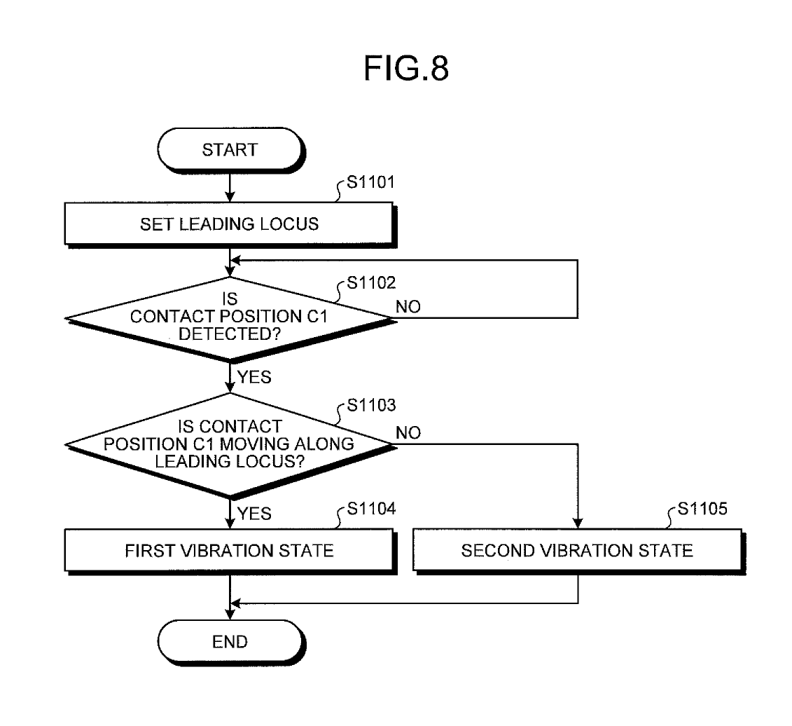

Next, a processing procedure executed by the input device 110 according to the present embodiment will be described with reference to FIG. 8. FIG. 8 is a flowchart illustrating the processing procedure executed by the input device 110 according to the present embodiment.

As illustrated in FIG. 8, the input device 110 sets a leading locus TA1 based on at least one of an object to be displayed on the display unit 120 and a contact position C1 of a user which position is detected by the detection unit 1141 (step S1101). Here, for example, the contact position C1 is a contact position C1 that is detected by the detection unit 1141 immediately before execution of the processing illustrated in FIG. 8. For example, when the detection unit 1141 detects the contact position C1, execution of the processing illustrated in FIG. 8 may be started.

Subsequently, the input device 110 determines whether the detection unit 1141 detects a contact position C11 (step S1102). Note that here, it is assumed that the contact position C11 detected by the detection unit 1141 is a position different from the above-described contact position C1. When the detection unit 1141 does not detect the contact position C11 (step S1102; No), the input device 110 goes back to step S1102 and waits for the detection of the contact position C11 by the detection unit 1141.

When the detection unit 1141 detects the contact position C11 (step S1102; Yes), the input device 110 determines whether the contact position C11 moves along the leading locus TA1 set in step S1101 (step S1103).

When the contact position C11 moves along the leading locus TA1 (step S1103; Yes), the input device 110 controls the vibration elements 1130a and 1130b of the vibration unit 1130 into the first vibration state (step S1104) and ends the processing.

When the contact position C11 does not move along the leading locus TA1, that is, when the contact position C11 moves in a manner deviated from the leading locus TA1 (step S1103; No), the input device 110 controls the vibration elements 1130a and 1130b of the vibration unit 1130 into the second vibration state (step S1105) and ends the processing.

Note that step S1101 and step S1102 may be executed simultaneously or executed in inverse order. Also, when the contact position C11 is not detected for a predetermined period in step S1102, it may be assumed that the input operation by the user is over and the processing may be ended.

### 1.5. Modification Example

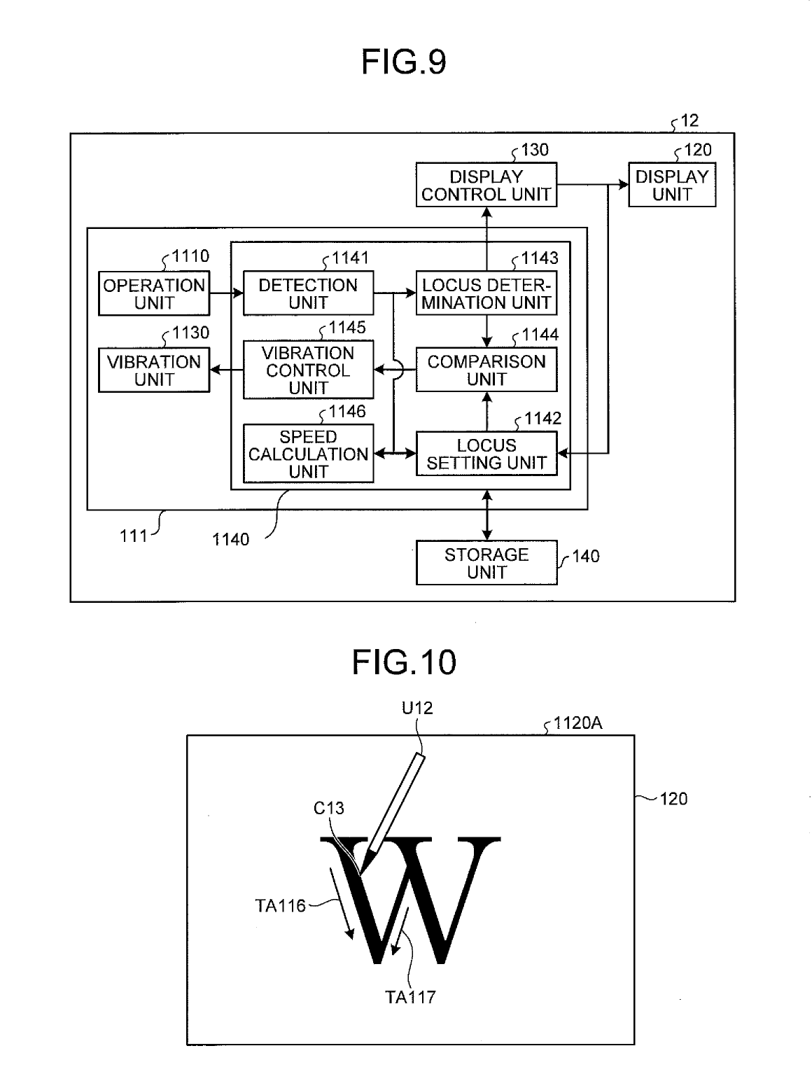

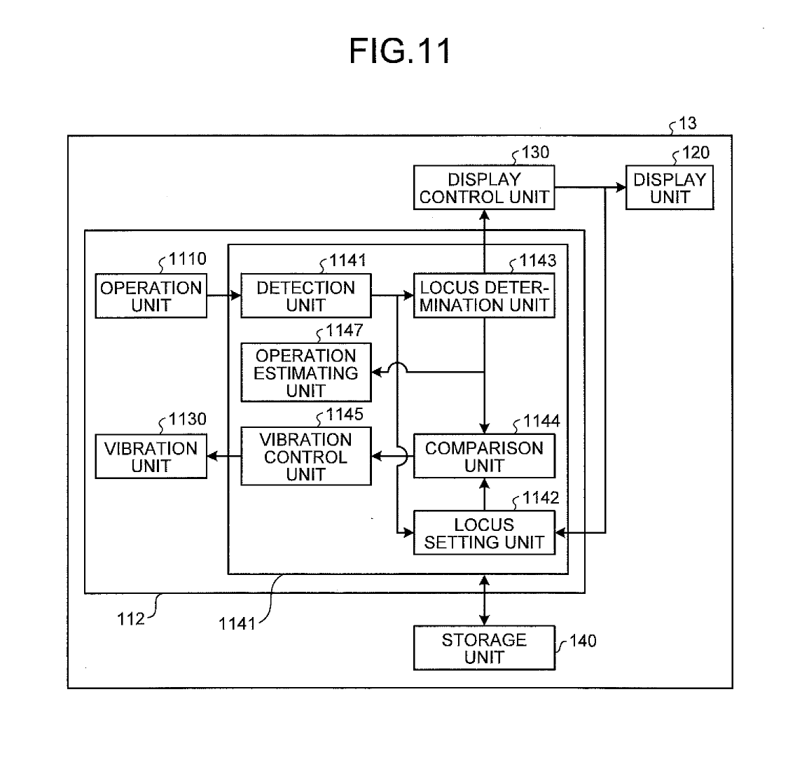

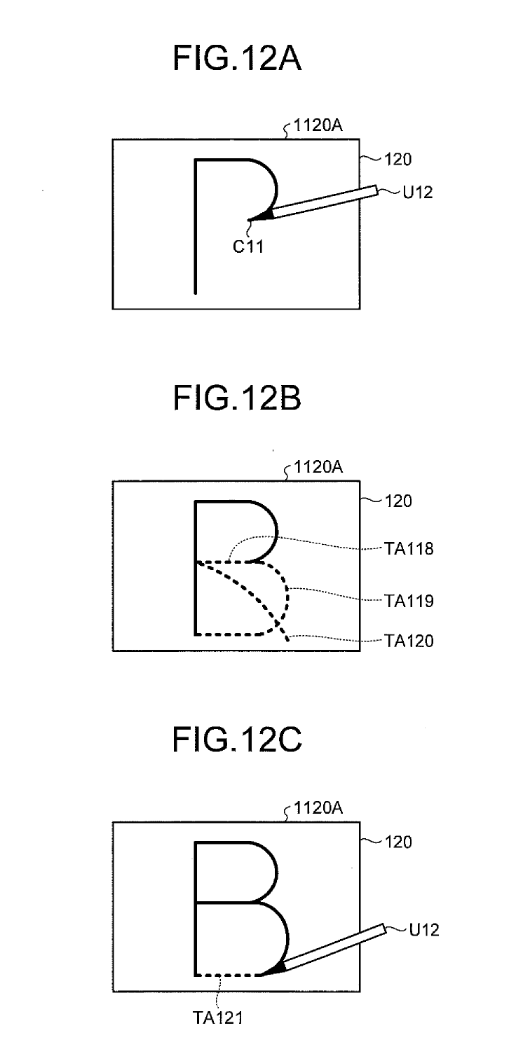

A modification example of the first embodiment will be described with reference to FIG. 9 to FIG. 12C. FIG. 9 and FIG. 10 are views for describing a first modification example of the present embodiment. Also, FIG. 11 and FIGS. 12A to 12C are views for describing a second modification example of the present embodiment.

### 1.5.1. First Modification Example

An input device 111 of a display device 12 according to the first modification example includes a speed calculation unit 1146 in addition to a configuration of the input device 110 illustrated in FIG. 2. Note that the same sign is assigned to a configuration identical to that in the display device 11 illustrated in FIG. 2 and a description thereof is omitted.

The speed calculation unit 1146 in FIG. 9 calculates a moving speed V1 of a contact position C1 according to a temporal change of the contact position C1 detected by a detection unit 1141. For example, when the detection unit 1141 detects the contact position C1 in a predetermined cycle, the speed calculation unit 1146 calculates a moving speed Yin at time T1n by calculating a distance between a contact position C1n at time T1n and a contact position C1(n−1) at time T1(n−1) and dividing the calculated distance by a predetermined cycle. The speed calculation unit 1146 outputs the calculated moving speed V1n to a vibration control unit 1145.

The vibration control unit 1145 changes a vibration state of vibration elements 1130a and 1130b of a vibration unit 1130 according to the moving speed V1 calculated by the speed calculation unit 1146. For example, when the moving speed V1 becomes higher, the vibration control unit 1145 decreases friction force between an operation surface 1120A and a contact surface of a user. Accordingly, it is possible to give smoother tactile perception to the user when the moving speed V1 becomes higher.

For example, a moving speed V1 and a vibration state of the vibration elements 1130a and 1130b are associated to each other and stored in a storage unit 140. When receiving a moving speed V1 from the speed calculation unit 1146, the vibration control unit 1145 refers to the storage unit 140 and determines a vibration state corresponding to the moving speed V1. The vibration control unit 1145 controls the vibration elements 1130a and 1130b in such a manner that the vibration elements 1130a and 1130b become the determined vibration state.

Alternatively, for example, the vibration control unit 1145 may determine a vibration state by comparing the moving speed V1 with a predetermined threshold. For example, when the moving speed V1 is higher than the predetermined threshold, the vibration control unit 1145 determines that a vibration state of the vibration elements 1130a and 1130b is set to a first vibration state. Also, when the moving speed V1 is equal to or lower than the predetermined threshold, it is determined that a vibration state of the vibration elements 1130a and 1130b is set to a third vibration state different from first and second vibration states. Here, it is assumed that the third vibration state is a state in which friction force between the operation surface 1120A and a contact surface of the user is higher than that in the first vibration state but is lower than that in the second vibration state.

In such a manner, tactile perception given to the user is changed according to the moving speed V1 of the user. More specifically, smoother tactile perception is given to the user when the moving speed V1 of the user becomes higher. Thus, it is possible to give smooth tactile perception, for example, when the user moves a finger U11 on the operation surface 1120A at high speed. Thus, it is possible to improve operability of the user.

Next, an application example of the input device 111 according to the present modification example will be described with reference to FIG. 10. In FIG. 10, for example, a case of practicing writing of an alphabet by using the input device 111 will be described.

In this case, a display unit 120 displays an alphabet to be written. Also, a locus setting unit 1142 sets a leading locus TA1 with a stroke of an alphabet, which is displayed on the display unit 120, as an object to be displayed. Here, for example, the locus setting unit 1142 sets the leading locus TA1 according to a contact position C1 of a user or stroke order of the alphabet.

More specifically, the locus setting unit 1142 sets the leading locus TA1 in order from a first stroke of the alphabet according to the stroke order of the alphabet. For example, when the user finishes writing of the first stroke, the locus setting unit 1142 sets a leading locus TA1 of a second stroke.

In such a manner, when order of input operation performed by a user is previously determined, a leading locus TA1 is set in order of the input operation. Accordingly, it becomes possible for the user to easily perform input operation in predetermined order and operability of the user is improved.

Also, when a user is writing a predetermined stroke, the locus setting unit 1142 sets a leading locus TA1 according to a contact position C1 of the user. For example, in FIG. 10, it is assumed that the user starts writing a first stroke of “W” and a stylus pen U12 of the user is in contact with the operation surface 1120A at a contact position C13.

In this case, the locus setting unit 1142 sets a leading locus TA116 with the contact position C13 as a starting point and an end of the first stroke as an end point. Here, the locus setting unit 1142 does not set a leading locus TA1 with the beginning of the first stroke as a starting point. Accordingly, the user hardly performs operation of going back to the beginning of the first stroke from the contact position C13.

In such a manner, when a direction of input operation performed by a user is previously determined, a leading locus TA1 is set in the direction of the input operation. Accordingly, it becomes easy for the user to perform input operation in the predetermined direction and operability of the user is improved.

Also, the vibration control unit 1145 determines a vibration state according to a moving speed V1 of the stylus pen U12. For example, in a case of writing a Chinese character, a moving speed V1 of the stylus pen U12 is increased in writing of a stroke with a tapered stroke/hook stroke as a final stroke compared to writing of a stroke with a stop stroke as a final stroke. Thus, the vibration control unit 1145 controls the vibration elements 1130a and 1130b into the third vibration state in a case where the stylus pen U12 moves along a leading locus TA1 of the stroke with the stop stroke as the final stroke and into the first vibration state when the stylus pen U12 moves along a leading locus TA1 of the stroke with the tapered stroke/hook stroke as the final stroke. Accordingly, it becomes possible for the user to smoothly write the stroke with the tapered stroke/hook stroke as the final stroke and operability of the user is improved.

Note that in FIG. 10, in order to make it easy to see the drawing, leading loci TA16 and TA17 are illustrated in a manner deviated from strokes of the alphabet. However, the locus setting unit 1142 actually sets the leading loci TA116 and TA117 on strokes of the alphabet.

Note that here, a vibration state of the vibration elements 1130a and 1130b is changed according to the moving speed V1 of the contact position C1 of the user. However, this is not the limitation. In a case where a degree of a moving speed V1 is associated to a stroke to be displayed, for example, in the above-described case of writing a Chinese character, a vibration state of the vibration elements 1130a and 1130b may be changed according to the object to be displayed.

For example, in writing of a Chinese character, a hook stroke or a tapered stroke of the Chinese character is written faster than a line written in a vertical direction or a horizontal direction. Thus, a stroke and a vibration state are associated to each other and are stored in the storage unit 140 in such a manner that a stroke of a hook stroke or a tapered stroke becomes a first vibration state and a stroke of a horizontal line or a vertical line becomes a third vibration state.

For example, in a case where the stylus pen U12 moves along a leading locus TA1 corresponding to a predetermined stroke, the vibration control unit 1145 refers to the storage unit 140 and controls the vibration elements 1130a and 1130b into a vibration state corresponding to the stroke.

As described, in a case where a moving speed V1 that is preferable to predetermined input operation is set, the vibration control unit 1145 controls the vibration elements 1130a and 1130b into a vibration state corresponding to the moving speed V1 associated to the input operation. Accordingly, it becomes easy for the user to perform input operation at a moving speed V corresponding to input operation and operability of the user is improved.

Note that in the above-described first modification example, a case of performing writing of a Chinese character has been described as an application example of the input device 111. However, this is not the limitation. For example, in a case of setting a leading locus TA16 from a contact position C11 to a predetermined target position such as a button B13 (see FIG. 5), a moving speed V1 may be increased when a distance between the contact position C11 and the target position becomes longer.

That is, when the distance between the contact position C11 and the target position becomes longer, friction force between the operation surface 1120A and a contact surface of the user is more decreased. Accordingly, when the distance between the contact position C11 and the target position becomes longer, the user can move the contact position C11 more smoothly. Thus, even when the distance between the contact position C11 and the target position is long, it is possible to move the contact position C11 to the target position in a short period and operability of the user is improved.

In such a manner, a vibration state of the vibration elements 1130a and 1130b may be changed according to a length of a set leading locus TA1. In a case of changing the leading locus TA1 dynamically according to a movement of the contact position C11, a vibration state of the vibration elements 1130a and 1130b may be changed according to the change in the leading locus TA1. Accordingly, for example, it is possible for a user to recognize whether a target position is getting closer.

### 1.5.2. Second Modification Example

An input device 112 of a display device 13 according to the second modification example includes an operation estimating unit 1147 in addition to a configuration of the input device 110 illustrated in FIG. 2. Note that the same sign is assigned to a configuration identical to that in the display device 11 illustrated in FIG. 2 and a description thereof is omitted.

According to a movement locus of a contact position C1 detected by a detection unit 1141, the operation estimating unit 1147 in FIG. 11 estimates input operation performed by a user. For example, the operation estimating unit 1147 estimates input operation by a user based on a movement locus determined by a locus determination unit 1143. A display device 13, for example, stores input operation received from a user and a locus of the input operation in a storage unit 140 while associating the two to each other.

For example, the operation estimating unit 1147 performs pattern matching of a locus of input operation which locus is stored in the storage unit 140 and a movement locus determined by the locus determination unit 1143 and estimates input operation according to a result of the matching. Here, the operation estimating unit 1147 estimates input operation in consideration of a starting point and an end point of a movement locus, that is, a moving direction of the movement locus or order of writing a plurality of movement loci. For example, the operation estimating unit 1147 outputs a result of the estimation to a vibration control unit 1145.

Note that pattern matching of a locus of input operation, which locus is stored in the storage unit 140, and a movement locus determined by the locus determination unit 1143 is performed, for example, by utilization of an algorithm of recognizing a handwritten character in a case where the movement locus is an online handwritten character. As an algorithm of recognizing a handwritten character, for example, there is a machine learning algorithm such as a support vector machine (SVM).

When the operation estimating unit 1147 estimates input operation, the vibration control unit 1145 vibrates vibration elements 1130a and 1130b in a vibration state different from a first vibration state. Accordingly, the input device 112 can notify a user that the input operation is estimated and the user does not need, for example, to keep performing the input operation after the estimation by the input device 112. Thus, it is possible to improve operability of the user.

Next, an application example of the input device 112 according to the present modification example will be described with reference to FIGS. 12A to 12C. In FIGS. 12A to 12C, for example, a case where the input device 112 receives input operation of a handwritten character online will be described.

As illustrated in FIG. 12A, a user inputs a handwritten character, for example, by moving a stylus pen U12 on an operation surface 1120A. The operation estimating unit 1147 estimates a character input by the user according to a movement locus of a contact position C1 detected by the detection unit 1141.

For example, it is assumed that input operation by a user is started and a contact position C1 moves to a position C11 illustrated in FIG. 12A. Here, for example, an operation estimating unit 1147 estimates “B,” “P,” and “R” as character candidates input by the user.

Here, as illustrated in FIG. 12B, a locus setting unit 1142 may set a leading locus TA1 based on the character candidates estimated by the operation estimating unit 1147. For example, the locus setting unit 1142 sets a first leading locus TA118 based on the character candidate “P” estimated by the operation estimating unit 1147. Similarly, for example, the locus setting unit 1142 sets a second leading locus TA119 based on the character candidate “B” and sets a third leading locus TA120 based on the character candidate “R.”

For example, the locus setting unit 1142 refers to the storage unit 140 and sets each leading locus TA1 based on a locus of input operation associated to a character candidate. The locus setting unit 1142 extends or contracts the referred locus of the input operation according to a movement locus, for example. Moreover, for example, the locus setting unit 1142 sets a locus, from which a part that matches the movement locus is removed, as a leading locus TA1 among loci of the input operation.

In such a manner, when the locus setting unit 1142 sets a leading locus TA1 according to a result of the estimation by the operation estimating unit 1147, it becomes possible for a user to easily perform input operation (here, handwritten character input) along the leading locus TA1.

As illustrated in FIG. 12C, a case where the user keeps performing the character input operation continuously from FIG. 12A will be described. In this case, it is assumed that the operation estimating unit 1147 estimates an input character and a character candidate is narrowed down to one. The operation estimating unit 1147 notifies a result of the estimation to the vibration control unit 1145. Note that it may be notified to the vibration control unit 1145 that the operation estimating unit 1147 ends estimation of input operation.

When receiving notification from the operation estimating unit 1147, the vibration control unit 1145 controls the vibration elements 1130a and 1130b into a vibration state different from the first vibration state. For example, it is assumed that a leading locus TA121 illustrated in FIG. 12C is set by the locus setting unit 1142. In this case, when a contact position C1 of the stylus pen U12 moves along the leading locus TA121 in a state in which notification from the operation estimating unit 1147 is not received, the vibration control unit 1145 controls the vibration elements 1130a and 1130b into the first vibration state. Thus, friction force between the stylus pen U12 and the operation surface 1120A is decreased and the contact position C1 of the stylus pen U12 can be moved smoothly.

Here, when notification from the operation estimating unit 1147 is received, the vibration control unit 1145 controls the vibration elements 1130a and 1130b into a vibration state, which is different from the first vibration state, such as a second vibration state. Thus, friction force between the stylus pen U12 and the operation surface 1120A is increased and it becomes not possible to move the contact position C1 of the stylus pen U12 smoothly. Accordingly, the user can recognize that recognition of a handwritten character is completed, and can end the operation even in the middle of the character input operation.

In such a manner, by making the vibration elements 1130a and 1130b vibrate in a vibration state different from the first vibration state in a case where the operation estimating unit 1147 estimates input operation, it is possible to guide a user to end the input operation. Accordingly, it is possible for a user to end operation even in the middle of the input operation and operability of the user can be improved.

Note that when the numbed of character candidates estimated by the operation estimating unit 1147 is equal to or larger than a predetermined number (see FIG. 12A), the locus setting unit 1142 may set, as a leading locus TA1, a region of receiving a handwritten input on the operation surface 1120A. Accordingly, wherever the contact position C1 of the user goes, the vibration control unit 1145 can determine that the contact position C1 moves along the leading locus TA1. That is, wherever the contact position C1 of the user goes, the vibration control unit 1145 can give smooth tactile perception to the user.

Accordingly, when the numbed of character candidates estimated by the operation estimating unit 1147 is equal to or larger than a predetermined number, the user can freely input a handwritten character. Also, when the number of character candidates becomes smaller than the predetermined number, it becomes possible to input a character according to one of the character candidates estimated by the input device 112. Thus, it becomes possible for a user to easily input a character and it is possible to improve accuracy in estimation of input operation which estimation is performed by the operation estimating unit 1147 of the input device 112.

Note that here, a case of performing an input of a handwritten character has been described as an application example of the input device 112. However, this is not the limitation. For example, application to a case of performing a gesture input in which a symbol such as an arrow or a character is input on the operation surface 1120A to perform operation corresponding to the symbol or character may be performed.

Here, in the gesture input, for example, a predetermined locus is input on the operation surface 1120A regardless of an object to be displayed which object is displayed on the display unit 120 and input operation corresponding to the predetermined locus is received. For example, there is operation of activating an AM radio when a user inputs a character “A” during an operation of car navigation or operation of adjusting a volume of a speaker when a user draw an arc on the operation surface 1120A.

Note that, for example, a predetermined locus and input operation are previously associated to each other to make the input device 112 receive gesture input operation. Alternatively, when a user arbitrarily inputs a locus and input operation corresponding to the input locus is determined, gesture input operation set by the user may be received by the input device 112.

In such a manner, when a user inputs a predetermined locus to the input device 112, the operation estimating unit 1147 estimates input operation according to the predetermined locus and the vibration control unit 1145 controls the vibration elements 1130a and 1130b into a vibration state different from the first vibration state according to a result of the estimation. Accordingly, the user can recognize whether the input device 112 receives gesture input.

Note that each of the above-described embodiment and modification examples, a state in which the vibration elements 1130a and 1130h vibrate with a high-frequency wave is a first vibration state and a non-vibration state in which the vibration elements 1130a and 1130b do not vibrate is a second vibration state. However, this is not the limitation. The vibration control unit 1145 changes a vibration state in such a manner that it becomes easy for a user to move a contact position C1 along a leading locus TA1 and that a deviation from the leading locus TA1 is decreased. That is, a change is made in such a manner that friction force between a user and an operation surface 1120A is decreased when a leading locus TA1 is followed and that friction force is increased when there is a deviation from the leading locus TA1.

Thus, as described, turning on/off of vibrations of the vibration elements 1130a and 1130b may be switched. For example, when vibration strength (amplitude), a vibration frequency, a vibration cycle, and on/off patterns of vibration (for example, pattern of keeping on state for 2 second after repetition of turning on/off twice at interval of 0.2 second is repeated) of the vibration elements 1130a and 1130b are switched, a vibration state of the vibration elements 1130a and 1130b may be changed. Alternatively, a vibration state may be changed by a combination of these.

### Second Embodiment

For example, a device such as a touch-pad in which device an input device is arranged separately from a display device such as a liquid crystal display has been known. For example, in a device disclosed in Japanese Laid-open Patent Publication No. 2013-159273, an operation switch is arranged in a periphery of a touch-pad.

However, in a conventional device, an operation switch is arranged in a periphery of a touch-pad and designability is not considered at all. Also, in a case of performing operation including a movement between a touch-pad and an operation switch, it is necessary to visually check a position of the operation switch at the time. Thus, for example, eyes-free operation performed without looking at a hand is not always performed smoothly. As described, in a conventional device, operability and a degree of freedom in designability are not high.

An input device according to the second embodiment of the present invention can improve operability and a degree of freedom in designability.

### 2.1. Method of Controlling Input Device

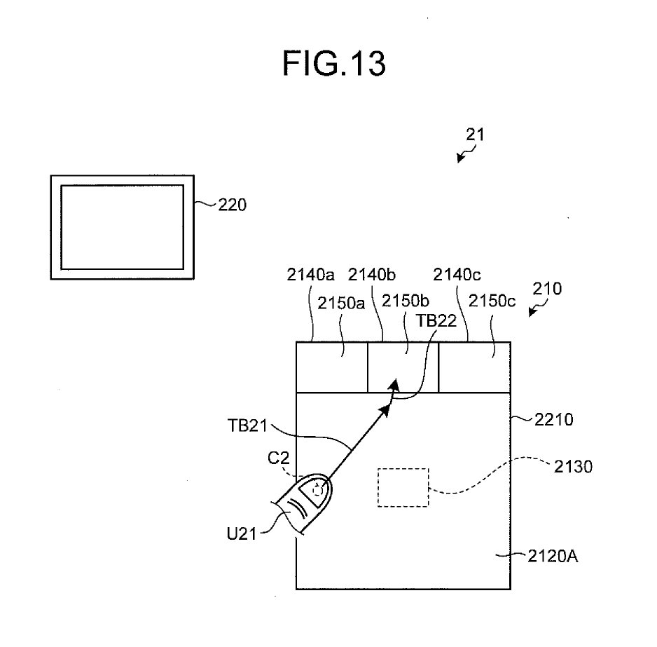

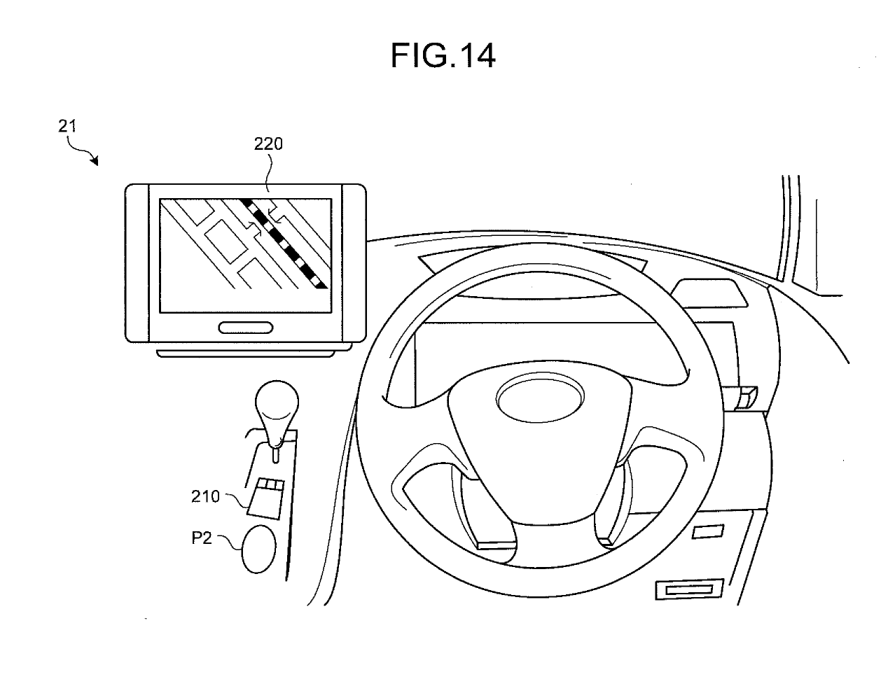

FIG. 13 is a view for describing a method of controlling an input device 210 according to the second embodiment of the present invention. In the present embodiment, for example, a case where an in-vehicle display device 21 to be installed in a car navigation system includes the input device 210 will be described.

First, an outline of the display device 21 according to the present embodiment will be described with reference to FIG. 13. Here, it is assumed that the display device 21 includes the input device 210 similarly to a touch panel.

As illustrated in FIG. 13, the display device 21 according to the present embodiment includes the input device 210 and a display unit 220. The display unit 220 is, for example, a liquid crystal display and displays an image for a user according to input operation received by the input device 210. The display unit 220 displays an image such as a map for navigation of a vehicle, a television show, a moving image on the Internet, or an image such as a still image.

The input device 210 is arranged at a place different from that of the display unit 220. The input device 210 receives input operation from a user. The input device 210 includes an operation unit 2110, a vibration element 2130 to vibrate an operation surface 2120A of the operation unit 2110, and first to third switch elements 2140a to 2140c.

The operation unit 2110 is, for example, a tabular pad having an information input function in an electrostatic capacitance system. The operation unit 2110 includes the operation surface 2120A. When a user touches the operation surface 2120A with a finger U21 or a pointing device such as a stylus pen, the input device 210 detects a contact position C2 of the user through the operation surface 2120A.

The vibration element 2130 is, for example, a piezoelectric element and vibrates the operation surface 2120A of the operation unit 2110 with a high-frequency wave (for example, in ultrasonic frequency band). For example, when the vibration element 2130 is vibrated in a state in which the finger U21 of the user is in contact with the operation surface 2120A, a state of an air layer between the finger U21 and the operation surface 2120A changes and friction force changes. When the finger U21 is moved in such a state, it is possible to give the finger U21 tactile perception corresponding to the changed friction force. Also, by changing a vibration state of the vibration element 2130, it is possible to change magnitude of the friction force between the finger U21 and the operation surface 2120A and to change the tactile perception given to the finger U21.

The first to third switch elements 2140a to 2140c (hereinafter, also referred to as switch 2140) respectively include pressed surfaces 2150a to 2150c and receive pressing operation by a user on the pressed surfaces 2150a to 2150c. The pressed surfaces 2150a to 2150c (hereinafter, also referred to as pressed surface 2150) are arranged in a manner adjacent to the operation surface 2120A on the same flat surface with the operation surface 2120A. Note that here, the pressed surfaces 2150a to 2150c and the operation surface 2120A are arranged on the same flat surface. However, this is not the limitation. The pressed surfaces 2150a to 2150c only need to be arranged on a smooth surface continuous with the operation surface 2120A or a surface without a discontinuous part therefrom. For example, the pressed surfaces 2150a to 2150c may be arranged on the same curved surface with the operation surface 2120A.

In such a manner, the input device 210 according to the present embodiment gives a user tactile perception by receiving input operation through the operation unit 2110 and the switch 2140 and vibrating the operation surface 2120A with the vibration element 2130. In the following, a method of controlling such an input device 210 will be described.

The input device 210 detects a contact position C2 of a user on the operation surface 2120A. The input device 210 controls the vibration element 2130 according to the detected contact position C2. For example, when the contact position C2 moves on the operation surface 2120A as indicated by an arrow TB21 in FIG. 13, the input device 210 controls the vibration element 2130 into a first vibration state.

Also, for example, when the contact position C2 moves between the operation surface 2120A and the pressed surface 2150 as indicated by an arrow TB22 in FIG. 13, the input device 210 controls the vibration element 2130 into a second vibration state.

Here, when a vibration state of the vibration element 2130 is the first vibration state, it is indicated that the vibration element 2130 vibrates with a high-frequency wave, for example. When the vibration element 2130 vibrates with the high-frequency wave, friction force between the operation surface 2120A and a contact surface of the user (such as finger U21) is decreased and the finger U21 of the user moves smoothly on the operation surface 2120A. That is, by changing the vibration state of the vibration element 2130 into the first vibration state, the input device 210 can give slippery smooth tactile perception to the finger U21 of the user, for example.

Also, when a vibration state of the vibration element 2130 is the second vibration state, a state in which the vibration element 2130 is not vibrated is indicated, for example. When the vibration element 2130 is not vibrated, predetermined friction force is generated between the operation surface 2120A and a contact surface of the user (such as finger U21) and the finger U21 of the user does not move smoothly on the operation surface 2120A compared to the first vibration state. That is, by changing the vibration state of the vibration element 2130 into the second vibration state, the input device 210 can give unsmooth tactile perception to the finger U21 of the user, for example.

Here, it is assumed that the finger U21 of the user moves from the operation surface 2120A to the pressed surface 2150 when the finger U21 of the user moves in order from the arrow TB21 to the arrow TB22. In this case, for example, the input device 210 gives smooth tactile perception to the finger U21 by controlling the vibration element 2130 into the first vibration state when the contact position C2 is along the arrow TB21 on the operation surface 2120A and gives high resistance to the finger U21 by controlling the vibration element 2130 into the second vibration state in a case of the arrow TB22.

Here, when moving from the operation surface 2120A to the pressed surface 2150, the user feels high resistance of getting over a step, for example. Accordingly, the input device 210 can make the user recognize a boundary between the operation surface 2120A and the pressed surface 2150.

In such a manner, in the method of controlling the input device 210 according to the present embodiment, when the contact position C2 moves on the operation surface 2120A, a vibration state of the vibration element 2130 is changed into the first vibration state and smooth tactile perception is given to the finger U21 of the user. Also, when the contact position C2 moves between the operation surface 2120A and the pressed surface 2150, a vibration state is changed into a second vibration state and unsmooth tactile perception is given.

Accordingly, even when a physical boundary is not provided between the operation surface 2120A and the pressed surface 2150 of the input device 210, it is possible to make a user recognize a boundary between the operation surface 2120A and the pressed surface 2150. Thus, for example, it becomes possible to form the operation unit 2110 and the switch 2140 of the input device 210 integrally and to improve a degree of freedom in designability of the input device 210.

Also, for example, even when designability of the input device 210 is valued and a physical boundary is not provided between the operation surface 2120A and the pressed surface 2150, it is possible to make a user to recognize a boundary between the operation surface 2120A and the pressed surface 2150 and to improve convenience in input operation performed by the user.

In a viewpoint of designability of the input device 210, design in which surfaces of an operation unit 2110 such as a touch-pad and the switch 2140 arranged therearound (operation surface 2120A and pressed surface 2150) are on a continuous surface (such as a flat surface or curved surface) is known as one kind of representative design. In a case of such design, it is difficult to recognize a region of each operation part (operation unit 2110 and the switch 2140), for example, in eyes-free operation performed without visual checking at a hand and there is a slight problem in operability.

In the input device 210 according to the present embodiment, the operation unit 2110 such as a touch-pad and the switch 2140 are arranged on the same flat surface, whereby a degree of freedom in designability is improved. In addition, since a movement between the operation unit 2110 and the switch 2140 on the same flat surface is notified by vibration, the movement between the operation unit 2110 and the switch 2140 can be performed, for example, by eyes-free operation performed without looking at a hand. Thus, it is possible to improve operability with respect to the input device 210.

For example, when the display device 21 including the input device 210 is installed in a vehicle, a driver who is a user needs to pay attention to a surrounding condition and may not be able to look at the input device 210 carefully during input operation. Even in such a case, by changing a vibration state of the vibration element 2130 and making a user recognize a boundary between the operation surface 2120A and the pressed surface 2150, it becomes possible for the user to operate the input device 210.

Note that here, a case where the display device 21 is a display device of a navigation system installed in a vehicle has been described. However, this is not the limitation. For example, the display device 21 may be a personal computer including a touch-pad or a pen tablet. In the following, the display device 21 including the input device 210 controlled by the control method will be further described.

### 2.2. Outline of Display Device 21

FIG. 14 is a view illustrating an outline of the display device 21 according to the present embodiment. As illustrated in FIG. 14, the display device 21 is installed in a vehicle. The display device 21 includes the display unit 220 and the input device 210. The display unit 220 of the display device 21 is arranged, for example, at a position that can be visually recognized by a driver on a driver's seat easily.

Also, the input device 210 is arranged at a position, where the driver can easily perform operation, such as a position near a shifter in a center console. In the example of FIG. 14, a palm rest P2 is arranged around the input device 210. When the palm rest P2 is provided around the input device 210, it is possible to reduce exhaustion of a user (driver) due to input operation.

Also, for example, a switch (not illustrated) may be provided in the palm rest P2 and the switch may be operated when a user presses the palm rest P2 with a palm. Note that as input operation received by the switch, there is confirmation operation of confirming operation selected with the input device 210. In such a manner, the input device 210 may include the palm rest P2 as a unit of receiving input operation.

Since the display unit 220 is arranged at a position that can be visually recognized by a user, who is a driver, easily and the input device 210 is arranged at a position away from the display unit 220 in such a manner that the driver can perform operation easily, the driver can easily perform input operation, for example.

### 2.3. Detail of Display Device 21

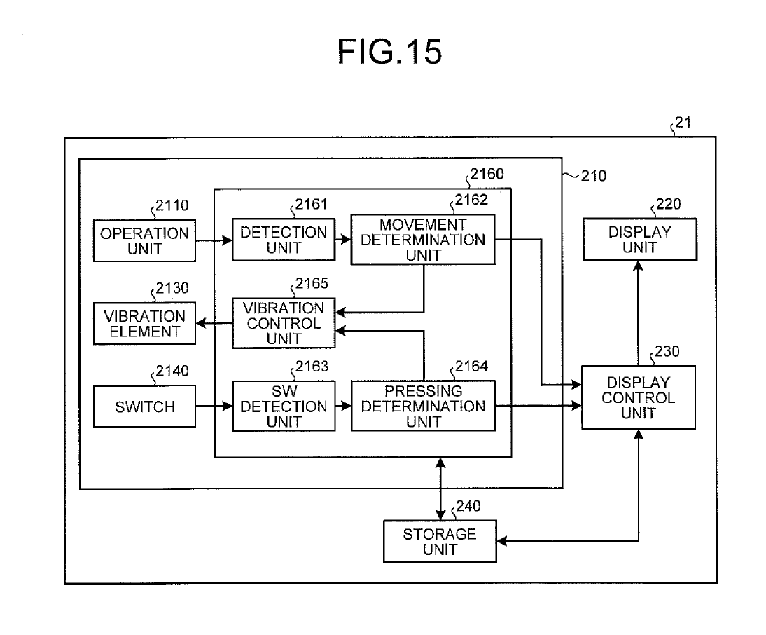

Next, a detail of the display device 21 will be described with reference to FIG. 15. FIG. 15 is a block diagram illustrating a configuration of the display device 21 according to the present embodiment. The display device 21 includes the input device 210, the display unit 220, a display control unit 230, and a storage unit 240.

2.3.1. Input Device 210

The input device 210 is an information input device such as a touch-pad or a switch. The input device 210 receives input operation performed by a user on the display device 21 and outputs, to the display control unit 230, a signal corresponding to the input operation by the user. The input device 210 includes the operation unit 2110, the vibration element 2130, the switch 2140, and a control unit 2160.

2.3.1.1. Operation Unit 2110

The operation unit 2110 is a tabular sensor such as a touch-pad or a pen tablet. As illustrated in Ms. 16A and 16B, the operation unit 2110 is arranged in a chassis 2170 of the input device 210. The operation unit 2110 includes the operation surface 2120A to receive input operation by a user. When the user touches the operation surface 2120A, the operation unit 2110 outputs a sensor value corresponding to a contact position C2 of the user to the control unit 2160.

2.3.1.2. Vibration Element 2130

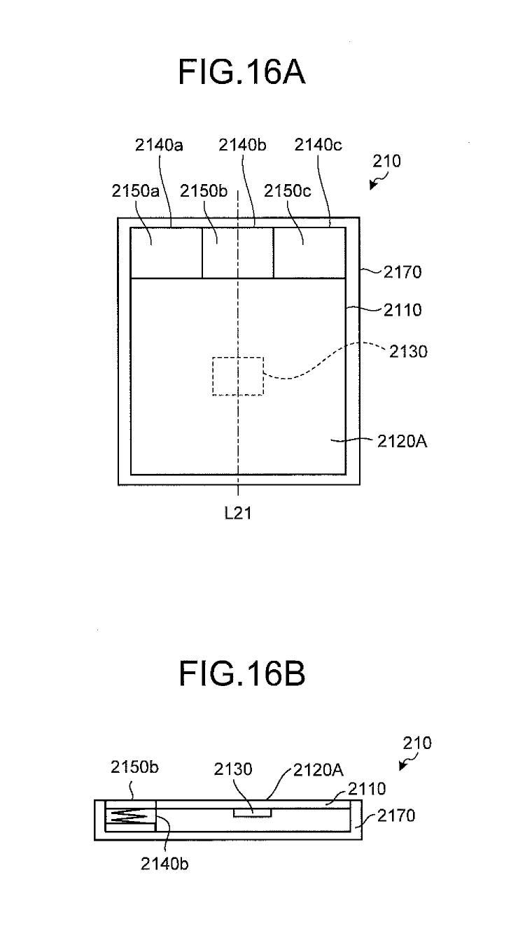

The vibration element 2130 is a piezoelectric actuator such as a piezoelectric element (piezo element). By being extended/contracted according to a voltage signal given by the control unit 2160, the vibration element 2130 vibrates the operation unit 2110. In an example of FIGS. 16A and 16B, the vibration element 2130 is arranged on a surface facing the operation surface 2120A of the operation unit 2110. Note that FIGS. 16A and 16B are a schematic view for describing an arrangement example of the vibration element 2130 and the switch 2140. A configuration element unnecessary for the description is not illustrated. FIG. 16A is a top view of the input device 210 and FIG. 16B is a sectional view of the input device 210 in a line L21 in FIG. 16A.

Note that the number and an arrangement of vibration elements 2130 illustrated in FIGS. 16A and 16B are just an example and these are not the limitations. For example, the operation surface 2120A may be vibrated with one or more vibration elements. As described, although the number and the arrangement of vibration elements 2130 are arbitrary, the number and the arrangement are preferably determined in such a manner that the whole operation surface 2120A is vibrated uniformly.

Also, here, a case of using a piezoelectric element as the vibration element 2130 has been described. However, this is not the limitation. For example, the vibration element 2130 may be an element of vibrating the operation surface 2120A in an ultrasonic frequency band.

2.3.1.3. Switch 2140

The switch 2140 includes, for example, the pressed surface 2150 and detects pressing operation on the pressed surface 2150 by a user. When the user presses the pressed surface 2150 of the switch 2140, a contact point (not illustrated) comes into contact and a signal is transmitted to the switch 2140, for example. For example, the switch 2140 outputs the signal to the control unit 2160. As illustrated in FIGS. 16A and 16B, the switch 2140 is arranged in the chassis 2170 of the input device 210 in a manner adjacent to the operation unit 2110.

In the example of FIG. 16A, the switch 2140 includes first to third switch elements 2140a to 2140c. The switch elements 2140a to 2140c are arranged in such a manner that one sides of corresponding pressed surfaces 2150a to 2150c are in contact with one side of an outer periphery of the operation surface 2120A. Also, as illustrated in FIG. 16B, the switch elements 2140a to 2140c are arranged in such a manner that the pressed surfaces 2150a to 2150c are on the same flat surface with the operation surface 2120A.

As illustrated in FIG. 16B, each of the first to third switch elements 2140a to 2140c includes an elastic body such as a spring. When a user presses the elastic bodies, contact points (not illustrated) of the first to third switch elements 2140a to 2140c come into contact and a signal is transmitted. Also, for example, when a user releases a finger from pressed surfaces 2150a to 2150c, the pressed surfaces 2150a to 2150c goes back to original positions by repulsive force of the elastic bodies. In such a manner, the first to third switch elements 2140a to 2140c are so-called mechanical switch units.

Note that here, it is assumed that the first to third switch elements 2140a to 2140c are mechanical switch units. However, this is not the limitation. Each of the first to third switch elements 2140a to 2140c only needs to be a switch that can detect pressing operation by a user and may be, for example, an electrostatic capacitance-type switch that can detect pressure vertical to the pressed surface 2150.

In FIGS. 16A and 16B, a case where the pressed surface 2150 of the switch 2140 and the operation surface 2120A of the operation unit 2110 include different flat plates is illustrated. However, this is not the limitation. For example, the pressed surface 2150 and the operation surface 2120A may include the same flat plate. Alternatively, the pressed surface 2150 and the operation surface 2120A may be formed integrally, for example, by being covered with a resin sheet. In such a manner, a degree of freedom in designability of the input device 210 can be improved.

Also, for example, the pressed surface 2150 and the operation surface 2120A may include the same flat plate and the pressed surface 2150 may be vibrated with the vibration element 2130. Alternatively, a vibration element to vibrate the pressed surface 2150 may be arranged to vibrate the pressed surface 2150. Accordingly, a movement between the pressed surface 2150 and the operation surface 2120A on the same flat surface can be notified by vibration and a movement between the pressed surface 2150 and the operation surface 2120A can be performed, for example, by eyes-free operation performed without looking at a hand, whereby it is possible to improve operability with respect to the input device 210.

Note that the number and an arrangement of switch elements illustrated in FIGS. 16A and 16B are just an example and these are not the limitations. For example, two switch elements may be arranged in a manner respectively in contact with different sides of the operation surface 2120A. In such a manner, although the number or the arrangement of switch elements is arbitrary, the number or the arrangement is preferably determined, for example, in such a manner that input operation can be performed even when a user does not visually recognize the input device 210.

2.3.1.4. Control Unit 2160

The control unit 2160 controls each unit of the input device 210. Also, the control unit 2160 outputs, to the display control unit 230, a signal corresponding to input operation received through the operation unit 2110 or the switch 2140. The control unit 2160 includes a detection unit 2161, a movement determination unit 2162, a switch detection unit (SW detection unit) 2163, a pressing determination unit 2164, and a vibration control unit 2165.

2.3.1.4.1. Detection Unit 2161

The detection unit 2161 detects a contact position C2 of a user on the operation surface 2120A based on a sensor value output by the operation unit 2110. For example, since the detection unit 2161 detects the contact position C2 of the user in a predetermined cycle, even when a finger U21 of the user moves on the operation surface 2120A and the contact position C2 changes, the detection unit 2161 can detect the contact position C2 along with the change. The detection unit 2161 outputs, to the movement determination unit 2162, the contact position C2 of the user which position is a result of the detection.

2.3.1.4.2. Movement Determination Unit 2162

Based on a result of the detection by the detection unit 2161, the movement determination unit 2162 determines whether the contact position C2 moves on the operation surface 2120A or the contact position C2 moves between the operation surface 2120A and the pressed surface 2150. For example, when the contact position C2 moves in an adjacent region D21 of the operation surface 2120A, the movement determination unit 2162 determines that the contact position C2 moves between the operation surface 2120A and the pressed surface 2150. Also, when the contact position C2 moves in a movement region D22 that is the operation surface 2120A excluding the adjacent region D21, it is determined that the contact position C2 moves on the operation surface 2120A.

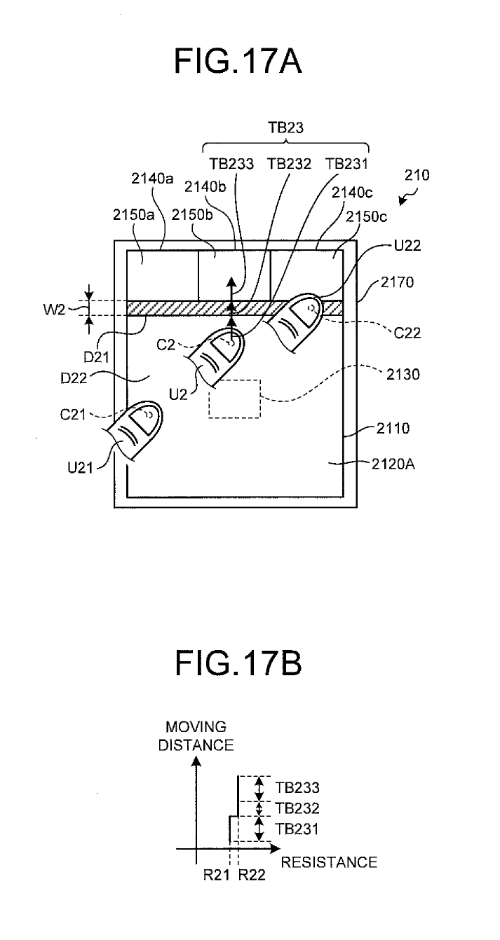

Here, a determination method in the movement determination unit 2162 will be described with reference to FIGS. 17A and 17B. FIGS. 17A and 17B are schematic view for describing a detail of the input device 210. First, the adjacent region D21 is an outer periphery region of the operation surface 2120A and indicates a region adjacent to the pressed surface 2150. In an example illustrated in FIG. 17A, the adjacent region D21 is a rectangular region that has, as a length, a side adjacent to the switch elements 2140a to 2140c of the operation surface 2120A and that has a predetermined width W2.

For example, as illustrated in FIG. 17A, when a contact position C21 of a user U21 is placed in the movement region D22, the movement determination unit 2162 determines that the contact position C21 moves in the movement region D22 and that the contact position C2 moves on the operation surface 2120A.

Also, for example, when a contact position C22 of a user U22 is placed in the adjacent region D21, the movement determination unit 2162 determines that the contact position C21 moves in the adjacent region D21 and that the contact position C2 moves between the pressed surface 2150 and the operation surface 2120A. The movement determination unit 2162 outputs a result of the determination to the vibration control unit 2165 and the display control unit 230.

Note that in the above-described example, it is assumed that the movement determination unit 2162 determines that the contact position C2 moves between the pressed surface 2150 and the operation surface 2120A when the contact position C2 is placed in the adjacent region D21. However, this is not the limitation. For example, it may be determined that there is a movement on the operation surface 2120A when the contact position C2 is placed on the operation surface 2120A and that the contact position C2 moves between the pressed surface 2150 and the operation surface 2120A when the contact position C2 is not placed on the operation surface 2120A.

Alternatively, when the contact position C2 detected in the adjacent region D21 is not detected on the operation surface 2120A or when the contact position C2 that is not detected on the operation surface 2120A is detected on the adjacent region D21, it may be determined that the contact position C2 moves between the pressed surface 2150 and the operation surface 2120A.

2.3.1.4.3. SW Detection Unit 2163

The SW detection unit 2163 is a switch unit to detect pressing operation on the pressed surface 2150 by a user. By detecting a signal that is output by the switch 2140 according to pressing operation by the user, the SW detection unit 2163 detects the pressing operation. The SW detection unit 2163 outputs a result of the detection to the pressing determination unit 2164.

2.3.1.4.4. Pressing Determination Unit 2164

According to a result of the detection by the SW detection unit 2163, the pressing determination unit 2164 determines which of the switch elements 2140a to 2140c of the switch 2140 is pressed. Also, according to a result of the detection by the SW detection unit 2163, the pressing determination unit 2164 determines whether the pressing operation is over, that is, the pressed surface 2150 is back to an original state.

In such a manner, the pressing determination unit 2164 determines whether the switch 2140 is pressed, and determines a position of the pressed surface 2150 of the switch 2140. The pressing determination unit 2164 outputs a result of the determination to the vibration control unit 2165 and the display control unit 230.

2.3.1.4.5. Vibration Control Unit 2165

According to a result of the determination by the movement determination unit 2162, the vibration control unit 2165 controls the vibration element 2130 into a first vibration state when the contact position C2 moves on the operation surface 2120A and into a second vibration state when the contact position C2 moves between the operation surface 2120A and the pressed surface 2150.

For example, as illustrated in FIG. 17A, when the contact position C21 is placed in the movement region D22, the vibration control unit 2165 controls the vibration element 2130 into a first vibration state in which friction force between a user and the operation surface 2120A is decreased. Also, for example, when the contact position C22 is placed in the adjacent region D21, the vibration control unit 2165 controls the vibration element 2130 into a second vibration state in which friction force between the user and the operation surface 2120A is increased.

Here, a case where a finger U2 moves along an arrow TB23 in FIG. 17A will be described. When the finger U2 moves along an arrow TB231, the contact position C2 is placed in the movement region D22. Thus, in this case, the vibration control unit 2165 controls the vibration element 2130 into the first vibration state. Accordingly, for example, as illustrated in FIG. 17B, the input device 210 can give predetermined resistance R21 to the finger U2 and it becomes easy for the user to move the finger U2 by slippery and smooth tactile perception.

When the finger U2 moves along an arrow TB232, the contact position C2 is placed in the adjacent region D21. Thus, in this case, the vibration control unit 2165 controls the vibration element 2130 into the second vibration state. Accordingly, for example, as illustrated in FIG. 17B, the input device 210 can give resistance R22, which is higher than the resistance R21, to the finger U2 and it becomes difficult for the user to move the finger U2 due to unsmooth tactile perception.

When the finger U2 moves along an arrow TB233, the finger U2 feels resistance corresponding to friction force on the pressed surface 2150b of the switch element 2140b. For example, as illustrated in FIG. 17B, when the pressed surface 2150 includes the same material with the operation surface 2120A of the operation unit 2110, the input device 210 gives the resistance R22 to the finger U2 and it becomes difficult for the user to move the finger U2 due to the unsmooth tactile perception.

Accordingly, as illustrated in FIG. 17B, resistance R2 is greatly increased when the finger U2 moves along the arrow TB23 and in a case where the finger U2 moves from the movement region D22 to the adjacent region D21. Thus, for example, the input device 210 can give tactile perception of getting over a step to the finger U2 on a side, where the movement region D22 and the adjacent region D21 are in contact with each other, and can make the user recognize a boundary of the operation surface 2120A and the pressed surface 2150. Thus, for example, even when the operation surface 2120A and the pressed surface 2150 are arranged on the same flat surface and it is hard to recognize a boundary between the operation surface 2120A and the pressed surface 2150, it is possible to make a user easily recognize the boundary.

The vibration control unit 2165 controls the vibration element 2130 according to a result of the determination by the pressing determination unit 2164. For example, when the finger U2 presses the switch 2140, the vibration control unit 2165 performs control in such a manner that the vibration element 2130 does not operate.

Also, when the pressing operation is over, the vibration control unit 2165 controls the vibration element 2130 into a predetermined vibration state. For example, the vibration control unit 2165 controls the vibration element 2130 into the second vibration state. Accordingly, the vibration control unit 2165 can give the resistance R22 to the finger U2 when the finger U2 moves from the pressed surface 2150 of the switch 2140 to the operation surface 2120A.

Moreover, when the finger U2 moves from the adjacent region D21 to the movement region D22 of the operation surface 2120A, the vibration control unit 2165 controls the vibration element 2130 into the first vibration state. Thus, even when the finger U2 moves from the pressed surface 2150 of the switch 2140 to the operation surface 2120A, tactile perception of stepping down a step can be given to the finger U2, for example.

Note that in a case of vibrating the pressed surface 2150 with the vibration element 2130, the vibration control unit 2165 controls the vibration element 2130 in such a manner that friction resistance between the pressed surface 2150 and the finger U2 changes. For example, in the arrow TB233 in FIG. 17A, the vibration control unit 2165 may control the vibration element 2130 into the first vibration state, that is, in such a manner that the resistance R21 is given to the finger U2.

In this case, the input device 210 gives the high resistance R22 to the finger U2 only when movement is along the arrow TB232 and can give tactile perception of getting over a protruded part to the finger U2, for example.

Also, when the finger U2 move between the switch elements 2140a to 2140c, the vibration control unit 2165 may control the vibration element 2130 in such a manner that friction resistance between the pressed surface 2150 and the finger U2 changes.

For example, an adjacent region is provided on sides of the switch elements 2140a to 2140c which sides are adjacent to each other. When a contact position C2 of a user is in the adjacent region, the vibration control unit 2165 controls the vibration element 2130 to vibrate in the second vibration state. When the contact position C2 of the user is placed in the pressed surface 2150 excluding the adjacent region, the vibration control unit 2165 controls the vibration element 2130 to vibrate in the first vibration state.

Accordingly, for example, when the contact position C2 of the user moves between the plurality of switch elements 2140a to 2140c, it is possible to make the user recognize a boundary between the plurality of switch elements 2140a to 2140c with a change in tactile perception on the adjacent region.

Also, the vibration control unit 2165 may change a vibration state of the vibration element 2130 according to a result of the detection by the SW detection unit 2163. For example, when the pressing determination unit 2164 determines that pressing operation on the switch 2140 is performed, the vibration control unit 2165 controls the vibration element 2130 into the first vibration state. Also, for example, when the pressing determination unit 2164 determines that the pressing operation on the switch 2140 is over, the vibration control unit 2165 controls the vibration element 2130 into the second vibration state.

Accordingly, for example, the input device 210 can give a user, who presses the switch 2140, tactile perception of pressing the switch 2140 in a stroke larger than it actually is or tactile perception of clicking the switch 2140, whereby operability of the user can be improved.

Note that a method of notifying a boundary in a case where there is a movement between the operation surface 2120A and the pressed surface 2150 is not limited to the above-described notification by tactile perception. For example, when there is a movement between the operation surface 2120A and the pressed surface 2150, sound may be output for notification. Here, for example, sound may be output through a speaker (not illustrated). Alternatively, the vibration element 2130 may be vibrated in an audible area by the vibration control unit 2165 and tactile sensation may be changed by a change in vibration, or sound may be output by vibration of the operation surface in an audible frequency. Alternatively, the vibration element 2130 may be controlled in such a manner that the input device 210 itself is vibrated and vibration may be directly transmitted to the user.

2.3.2. Display Unit 220

The display unit 220 is, for example, a liquid crystal display and presents an image output by the display control unit 230 to a user. The display unit 220 is a so-called remote display that is arranged at a position away from the input device 210.

2.3.3. Display Control Unit 230

For example, based on input operation received by the input device 210 from the user, the display control unit 230 generates an image to be displayed on the display unit 220. Also, the display control unit 230 generates an image corresponding to the contact position C2 on the operation surface 2120A which position is detected by the input device 210. The display control unit 230 outputs the generated image to the display unit 220. The display control unit 230 controls the display unit 220 to present the image to a user.

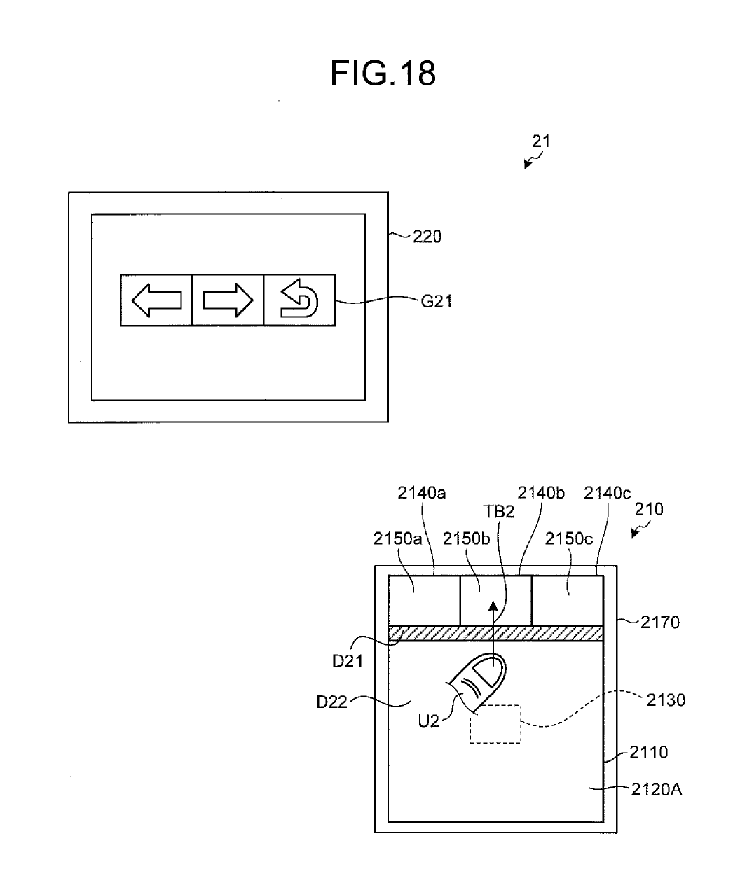

The display control unit 230 generates an image corresponding to a result of the determination by the movement determination unit 2162 of the input device 210 and displays the image on the display unit 220. For example, as illustrated in FIG. 18, when the finger U2 of the user moves along the arrow TB2 from the operation surface 2120A to the pressed surface 2150b, the display control unit 230 generates an image G21 corresponding to pressing operation received by the switch 2140 and displays the image on the display unit 220. Note that FIG. 18 is a view illustrating an example of the image G21 displayed on the display unit 220.

Also, the display control unit 230 changes a display color of the image G21 corresponding to the switch 2140 according to a result of the determination by the pressing determination unit 2164 of the input device 210 and displays the image on the display unit 220. For example, the image G21 corresponding to the switch 2140 on which the pressing operation is performed is displayed on the display unit 220 with the display color thereof being changed, whereby the pressed switch 2140 is notified to the user. In such a manner, the display control unit 230 displays, on the display unit 220, the image G21 corresponding to the pressing operation on the switch 2140 detected by the SW detection unit 2163.

Also, the pressing determination unit 2164 may determine, for example, which of the switch elements 2140a to 2140c is touched by the user. In this case, the display control unit 230 changes a display color of an image G21 corresponding to the switch 2140 touched by the user and displays the image G21 on the display unit 220.

In such a manner, the display control unit 230 displays, on the display unit 220, the image G21 corresponding to the input device 210 according to touching operation of the user. Accordingly, it becomes easy for the user to perform input operation while visually recognizing the display unit 220 instead of the input device 210.

Also, friction force on the operation surface 2120A of the input device 210 is changed and a position of the switch 2140 of the input device 210 is recognized by a user with tactile perception. In addition, the image G21 corresponding to the switch 2140 is displayed on the display unit 220, whereby a position of the switch 2140 is also recognized by the user visually. Accordingly, it is possible to further improve operability with respect to input operation by the user.

2.3.4. Storage Unit 240

The storage unit 240 stores, for example, the adjacent region D21 or the movement region D22 used by the movement determination unit 2162 for determination of the contact position C2. Also, the storage unit 240 stores a result of the determination by the movement determination unit 2162 or the pressing determination unit 2164. The storage unit 240 stores the image G21 generated by the display control unit 230. In such a manner, the storage unit 240 stores information necessary for processing performed by each unit of the display device 21 and a result of processing.

The storage unit 240 is a semiconductor memory element such as a random access memory (RAM) or a flash memory, or a storage device such as a hard disk or an optical disk.

### 2.4. Control Processing

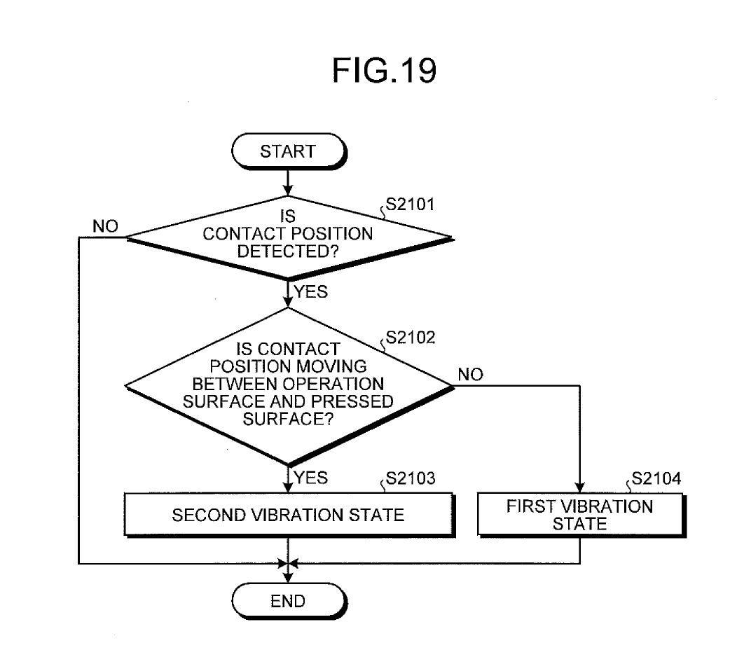

Next, a processing procedure executed by the input device 210 according to the present embodiment will be described with reference to FIG. 19. FIG. 19 is a flowchart illustrating the processing procedure executed by the input device 210 according to the present embodiment.

As illustrated in FIG. 19, the input device 210 determines whether the detection unit 2161 detects the contact position C2 of the user (step S2101). When the detection unit 2161 does not detect the contact position C2 (step S2101; No), the input device 210 ends the processing.

When the detection unit 2161 detects the contact position C2 (step S2101; Yes), the input device 210 determines whether the contact position C2 moves between the operation surface 2120A and the pressed surface 2150 (step S2102).

When the contact position C2 moves between the operation surface 2120A and the pressed surface 2150 (step S2102; Yes), the input device 210 controls the vibration element 2130 into the second vibration state (step S2103) and ends the processing.

When the contact position C2 does not move between the operation surface 2120A and the pressed surface 2150, that is, when the contact position C2 moves on the operation surface 2120A (step S2102; No), the input device 210 controls the vibration element 2130 into the first vibration state (step S2104) and ends the processing.

### 2.5. Modification Example

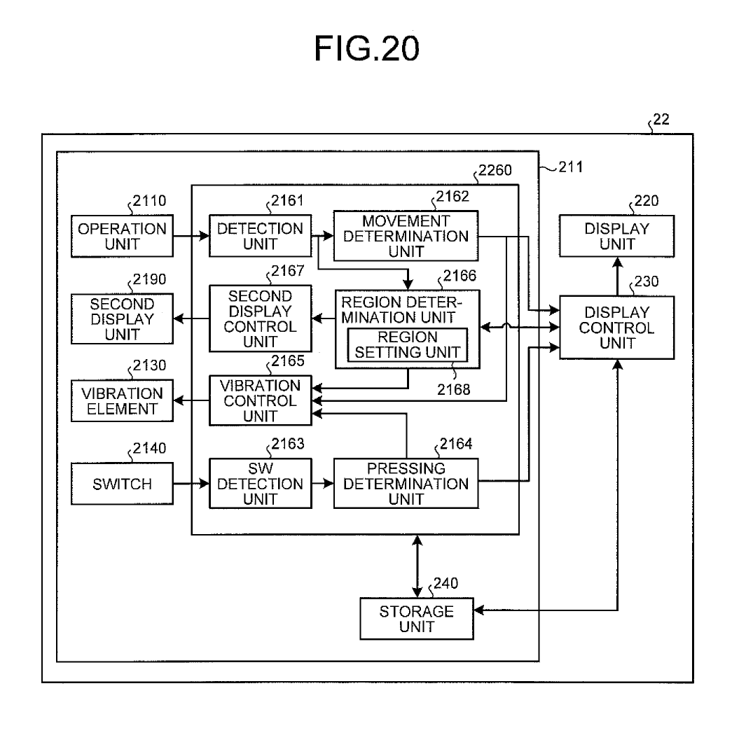

A modification example of the second embodiment will be described with reference to FIG. 20 to FIG. 24. FIG. 20 is a block diagram illustrating a configuration of a display device 22 according to the present modification example. An input device 211 of a display device 22 according to the present modification example includes a second display unit 2190 and a control unit 2260 in addition to a configuration of the input device 210 illustrated in FIG. 15. The control unit 2260 includes a region determination unit 2166 and a second display control unit 2167 in addition to a configuration of the control unit 2160 illustrated in FIG. 15. Note that the same sign is assigned to a configuration identical to that in the display device 21 illustrated in FIG. 15 and a description thereof is omitted.

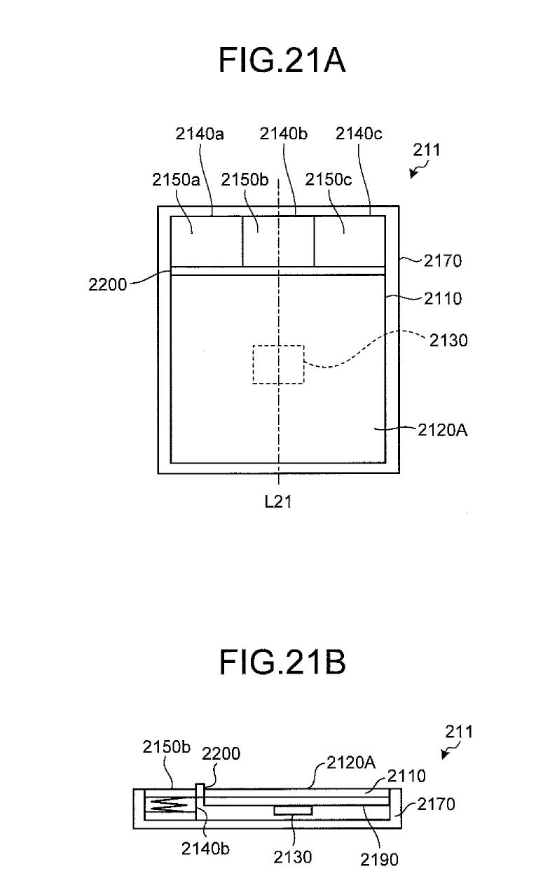

The second display unit 2190 is, for example, a liquid crystal display and is arranged in contact with a surface facing an operation surface 2120A of an operation unit 2110, as illustrated in FIG. 21B. Here, the operation unit 2110 is a transmissive panel, such as a touch panel, which has an information input function in an electrostatic capacitance system. As illustrated in FIGS. 21A and 21B, the operation unit 2110 of the input device 211 includes a step 2200 with a predetermined height between the operation surface 2120A and a pressed surface 2150. The step 2200 is formed in such a manner as to be higher than a flat surface on which the operation surface 2120A and the pressed surface 2150 are formed. Note that FIGS. 21A and 21B are schematic view illustrating a configuration of the input device 211 according to the present modification example. FIG. 21A is a top view of the input device 211 and FIG. 21B is a sectional view of the input device 211 in a line L21 in FIG. 21A.

The second display unit 2190 displays an image generated by the second display control unit 2167. A user can visually recognize the image, which is displayed on a display region of the second display unit 2190, through the transmissive operation surface 2120A. Note that here, the second display unit 2190 is, for example, a display unit resolution of which is lower than that of a display unit 220 and which is simpler than the display unit 220.

Alternatively, for example, the second display unit 2190 may include a plurality of pieces of lighting such as an LED light. In this case, the second display unit 2190 turns on/off the LED light according to an instruction from the second display control unit 2167.

The region determination unit 2166 includes a region setting unit 2168 to set a divided region in the operation surface 2120A based on an image displayed on the display unit 220. When receiving information related to the image displayed on the display unit 220 from a display control unit 230, the region setting unit 2168 divides the operation surface 2120A based on the information and sets the divided region.

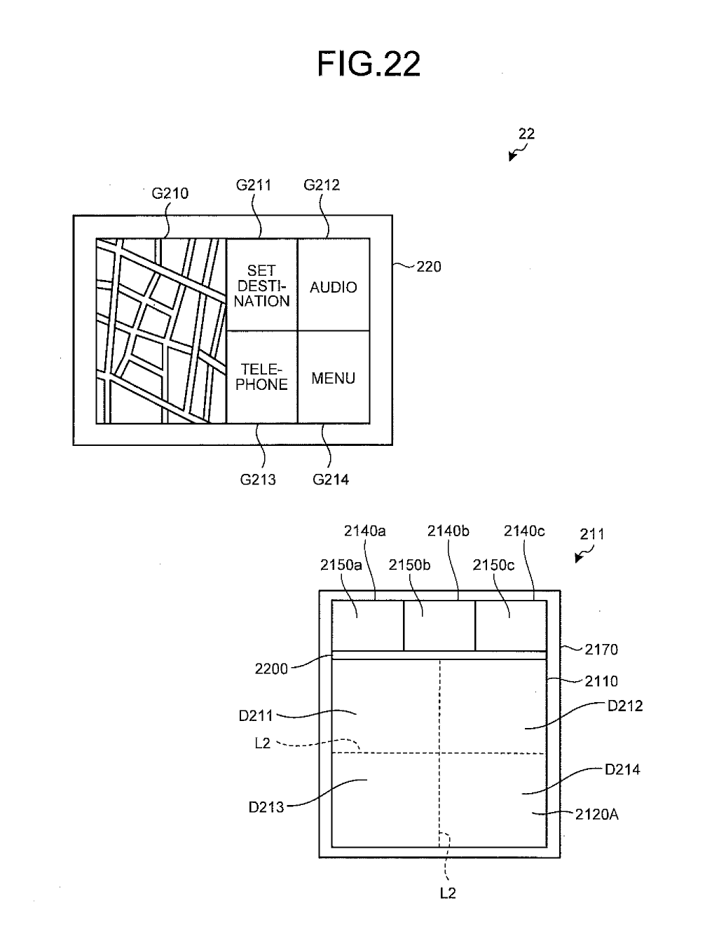

With reference to FIG. 22, the divided region will be described. FIG. 22 is a view for describing divided regions D211 to D214. For example, as illustrated in FIG. 22, it is assumed that an image G210 expressing a map and images G211 to G214 corresponding to four kinds of operation received by the display device 22 are displayed on the display unit 220. In this case, the region setting unit 2168 divides, with a boundary line L2, the operation surface 2120A into four divided regions D211 to D214 corresponding to the images G211 to G214.

Note that the divided regions D211 to D214 illustrated in FIG. 22 are examples and the number of regions and an arrangement are not limited to this. The divided regions D211 to D214 are set in such a manner as to correspond to an image displayed on the display unit 220 and the number and an arrangement thereof are arbitrary.

Based on a result of detection by a detection unit 2161, the region determination unit 2166 determines whether a contact position C2 moves in a first region (such as divided region D211) of the operation surface 2120A, moves in a second region (such as divided region D212) adjacent to the first region of the operation surface 2120A, or moves between the first and second regions. That is, the region determination unit 2166 determines whether the contact position C2 moves in the plurality of divided regions D211 to D214 or moves between the plurality of divided regions D211 to D214.

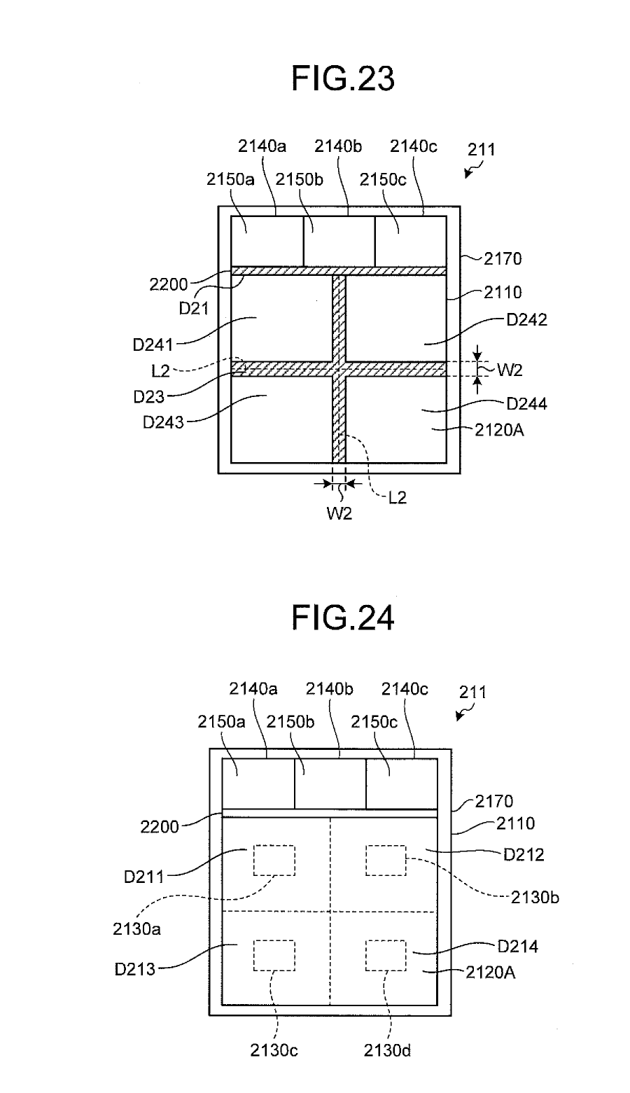

For example, as illustrated in FIG. 23, the region determination unit 2166 sets a second adjacent region D23 including the boundary line L2 between the divided regions D211 to D214 set by the region setting unit 2168. For example, as illustrated in FIG. 22, when four divided regions D211 to D214 with two rows and two columns are set on the operation surface 2120A, the second adjacent region D23 becomes a cross-shaped region D23 that has a width W and the four divided regions D211 to D214, as illustrated in FIG. 23. Note that FIG. 23 is a view for describing the second adjacent region D23.

Based on a result of the detection by the detection unit 2161, for example, when a contact position C2 of a user U2 is placed in movement regions D241 to D244 excluding the second adjacent region D23, the region determination unit 2166 assumes that the contact position C2 moves in the movement regions D241 to D244 and determines that the contact position C2 moves in the divided regions D211 to D214 of the operation surface 2120A.

Also, for example, when the contact position C2 of the user U2 is placed in the second adjacent region D23, the region determination unit 2166 assumes that the contact position C2 moves in the second adjacent region D23 and that the contact position C2 moves between the divided regions D211 to D214. The region determination unit 2166 outputs a result of the determination to a vibration control unit 2165 and the second display control unit 2167. Also, the region determination unit 2166 outputs, to the second display control unit 2167, information related to the divided regions D211 to D214 set by the region setting unit 2168.

Based on a result of the determination by the region determination unit 2166, the vibration control unit 2165 controls a vibration element 2130 into a first vibration state when the contact position C2 moves in the first or second region and into a second vibration state when the contact position C2 moves between the first and second regions.

For example, in examples illustrated in FIG. 22 and FIG. 23, when the contact position C2 is placed in the movement regions D241 to D244, the vibration control unit 2165 controls the vibration element 2130 into the first vibration state in which friction force between the user and the operation surface 2120A is decreased. Also, for example, when the contact position C2 is placed in the second adjacent region D23, the vibration control unit 2165 controls the vibration element 2130 into the second vibration state in which friction force between the user and the operation surface 2120A is increased.

Accordingly, when the contact position C2 moves between the divided regions D211 to D214, it is possible, for example, to give tactile perception of getting over a step to a finger U2 at a boundary of the divided regions D211 to D214 and to make the user recognize the boundary of the divided regions D211 to D214. Thus, when the operation surface 2120A is divided into the plurality of divided regions D211 to D214, it becomes possible for a user to recognize the divided regions D211 to D214 with tactile perception.

Note that in the example illustrated in FIG. 23, an adjacent region D21 provided in a boundary of the operation surface 2120A and the pressed surface 2150 is the same region with the step 2200. Accordingly, when the finger U2 of the user gets over the step 2200, it is possible to increase friction force between the user and the step 2200, whereby it becomes easy for the user to recognize the step 2200, for example, even in a case where a height of the step 2200 is low. Thus, for example, even in a case where the step 2200 is provided between the operation surface 2120A and the pressed surface 2150, it is possible to set the height of the step 2200 low and to improve a degree of freedom in designability of the input device 210. In such a manner, the operation surface 2120A and the pressed surface 2150 are arranged on the same flat surface to improve a degree of freedom in designability and a movement between the operation surface 2120A and the pressed surface 2150 on the same flat surface is notified with vibration and a step, whereby it is possible to perform a movement between the operation surface 2120A and the pressed surface 2150, for example, by eyes-free operation performed without looking at a hand and to improve operability with respect to the input device 210.

The second display control unit 2167 displays, on the second display unit 2190, an image corresponding to a result of the determination by the region determination unit 2166 or information related to the divided regions D211 to D214. For example, the boundary line L2 of the divided regions D211 to D214 is displayed on the second display unit 2190. Alternatively, a background color of a divided region (such as divided region D211) where the contact position C2 of the user is placed is changed to a color different from those of the other divided regions (such as divided region D212 to D214) to notify a position of the finger U2 of the user on the operation surface 2120A.

Also, the second display control unit 2167 may display, on the second display unit 2190, an image corresponding to the image displayed on the display unit 220. For example, as illustrated in FIG. 22, in a case where an image G213 including a character “telephone” is displayed on the display unit 220, an icon of a telephone is displayed on the corresponding divided region D213.

In such a manner, since the second display unit 2190 displays a simple image corresponding to an image displayed on the display unit 220, it is possible for a user to perform input operation while visually recognizing the input device 211 and it is possible to improve convenience in operation by the user.

Note that in the above-described input device 211, for example, one vibration element 2130 is arranged around a center part of the operation unit 2110 as illustrated in FIGS. 21A and 21B. However, the number and an arrangement of vibration elements 2130 are not limited this. For example, a vibration element 2130 may be provided in such a manner as to correspond to the divided regions D211 to D214 set by the region setting unit 2168. In FIG. 24, for example, vibration elements 2130a to 2130d are respectively provided around a center part of divided regions D211 to D214. Since the vibration elements 2130 are provided in such a manner as to correspond to the divided regions D211 to D214, it is possible to vibrate each of the divided regions D211 to D214 of the operation surface 2120A.

Also, in a case where each of the above-described input devices 210 and 211 includes a palm rest P2 illustrated in FIG. 14 and when the palm rest P2 is pressed by the user with a palm and a switch (not illustrated) of the palm rest P2 is operated, a vibration state of the vibration element 2130 may be changed according to determination whether operation of pressing the palm rest P2 is performed.

For example, when the SW detection unit 2163 detects the pressing operation on the palm rest P2, the vibration control unit 2165 controls the vibration element 2130 into the first vibration state and when the SW detection unit 2163 does not detect the pressing operation on the palm rest P2, the vibration control unit 2165 controls the vibration element 2130 into the second vibration state. Accordingly, for example, in a state in which the palm rest P2 is pressed, a finger moves smoothly and it becomes easy for the user to simultaneously perform the pressing operation on the palm rest P2 and touching operation on the operation unit 2110.

Also, when the user touches an arbitrary position on the operation surface 2120A of each of the above-described input devices 210 and 211, a vibration state of the vibration element 2130 may be changed. For example, based on a result of the detection by the detection unit 2161, in a case where a center part of the operation surface 2120A is touched, the vibration control unit 2165 controls the vibration element 2130 into a vibration state different from a vibration state of when a region other than the center part is touched.

Accordingly, for example, even when the user performs touching operation on the operation surface 2120A without visually recognizing the input device 210 or 211, it is possible to present a predetermined position on the operation surface 2120A to the user.

Also, the above-described input devices 210 and 211 may perform user authentication by using biometrics authentication such as fingerprint authentication or vein authentication. For example, setting such as a first vibration state or a second vibration state of the input devices 210 and 211 may be changed with respect to each user and the vibration control unit 2165 may vibrate the vibration element 2130 according to a result of the authentication of the user.

Also, for example, when an image of receiving pressing operation on the switch 2140 is displayed on the display unit 220, a vibration state of the vibration element 2130 may be changed in such a manner that the finger U2 moves smoothly from the contact position C2 of the user on the operation surface 2120A to the switch 2140.

For example, the control units 2160 and 2260 of each of the input devices 210 and 211 set a guiding locus from the contact position C2 to the switch 2140. When the contact position C2 moves to the switch 2140 along the guiding locus, the vibration control unit 2165 performs control in such a manner that friction force between the user and the operation surface 2120A is decreased, that is, the vibration element 2130 becomes the first vibration state.

Also, when the contact position C2 moves in a manner deviated from the guiding locus to the switch 2140, the vibration control unit 2165 performs control in such a manner that friction force between the user and the operation surface 2120A is increased, that is, the vibration element 2130 becomes the second vibration state.

### Different Modification Example

In the following, examples of various embodiments of a method of giving tactile sensation or the like in each of input devices 110, 210, and 211 to give tactile perception to a user by vibrating an operation surface will be described. Tactile sensation having various effects can be given to a user by arbitrary combination of these technologies of giving tactile sensation including the above-described technology.

The above-described embodiments and modification examples are not the limitation. For example, a switch 2140 of each of the input devices 110, 210, and 211 receives input operation of performing volume adjustment of a speaker (not illustrated) or temperature adjustment of an air conditioner (not illustrated), tactile perception to be given to a user may be changed according to a volume or temperature.

For example, when a user performs volume adjustment of a speaker or temperature adjustment of an air conditioner, vibration control units 1145 and 2165 switch operation frequencies of vibration units 1130 and 2130 in a predetermined cycle, that is, switch magnitude of friction force between operation surfaces 1120A and 2120A and a contact surface of the user. Accordingly, for example, it is possible to give rough tactile perception to a user. Thus, it is possible to give a user tactile perception corresponding to a volume of a speaker or a set temperature of an air conditioner.

Here, for example, as the volume of the speaker becomes higher or the set temperature of the air conditioner becomes higher, a predetermined cycle for switching an operation frequency is made longer. Also, as the volume of the speaker becomes lower or the set temperature of the air conditioner becomes lower, a predetermined cycle for switching an operation frequency is made shorter.

Also, for example, when a user makes a volume of the speaker or a set temperature of the air conditioner higher, protruded tactile perception as if operation surfaces 1120A and 2120A are expanded may be given to the user and when a volume of the speaker or a set temperature of the air conditioner is made lower, recessed tactile perception as if the operation surfaces 1120A and 2120A are recessed may be given to the user. Accordingly, the user can recognize, with tactile perception, what kind of operation is performed.

Also, for example, when the control units 1140 and 2160 determines that a user touches the operation surfaces 1120A and 2120A for a predetermined period or longer according to a result of the detection by the detection units 1141 and 2161, display control units 130 and 230 and the second display control unit 2167 may display a predetermined operation menu button on the display unit 220, the second display unit 2190, and the like according to a result of the determination.

The operation menu button is, for example, a circular button along a circumference of which an image indicating operation an input of which is received is arranged. For example, the user selects operation by moving contact positions C1 and C2 along an outer periphery of the operation menu button.

Here, rough tactile perception is given to the user along with a rotation of the circular button performed according to touching operation by the user, whereby tactile perception as if a dial is actually turned can be given. For example, the vibration control units 1145 and 2165 switch operation frequencies of the vibration units 1130 and 2130 in a predetermined cycle, that is, switch magnitude of friction force between the operation surfaces 1120A and 2120A and a contact surface of the user. Accordingly, for example, it is possible to give rough tactile perception to a user.

Also, for example, in a case of receiving input operation, which cannot be canceled once the operation is executed, such as complete deletion of a file, the input devices 110, 210, and 211 may give, with tactile perception, warning indicating that it is not possible to cancel the input operation and to recover an original state once the operation is received. For example, friction force on the operation surfaces 1120A and 2120A is increased as the contact positions C1 and C2 of the user become closer to a button of receiving operation that cannot be canceled.

More specifically, for example, the locus setting unit 1142 of the first embodiment sets, with the button as a target position, a leading locus TA1 from the contact position C1 of the user to the target position. The vibration control unit 1145 changes a vibration state of the vibration unit 1130 according to a length of the leading locus TA1. For example, the vibration control unit 1145 decreases friction force on the operation surface 1120A as a length of the leading locus TA1 becomes longer and friction force on the operation surface 1120A is increased as a length of the leading locus TA1 becomes shorter.

Accordingly, it is possible to increase resistance given to fingers U11 and U2 of a user as contact positions C1 and C2 of the user become closer to the button and to give warning to the user with tactile perception.

Also, in a case where the user performs input operation with respect to the input devices 110, 210, and 211, for example, when an obstacle is getting closer to a vehicle or when the user looks at the display units 120 and 220 or the input devices 210 and 211 carefully, there is a case where it is necessary to notify dander to the user. Here, the input devices 110, 210, and 211 may notify danger by giving specific tactile perception to the user.

For example, when it becomes necessary to notify danger to a user, the input devices 110, 210, and 211 notify the danger by greatly changing tactile perception given to the user. For example, in a case where the vibration control units 1145 and 2165 control the vibration units 1130 and 2130 in such a manner that high friction force is given to the user, the vibration units 1130 and 2130 are controlled in such a manner that the friction force becomes close to zero. Accordingly, tactile perception as if the fingers U11 and U2 slide suddenly can be given to the user.

Also, for example, in a case where the vibration control units 1145 and 2165 control the vibration units 1130 and 2130 in such a manner that low friction force is given to the user, the vibration units 1130 and 2130 are controlled in such a manner that the friction force becomes the maximum. Accordingly, it is possible to give tactile perception as if smoothly-moving fingers U11 and U2 stop suddenly.

In such a manner, the input devices 110, 210, and 211 can notify danger by suddenly changing tactile perception given to the user. Note that it is determined whether an obstacle is getting closer to a vehicle based on a result of detection performed by a proximity sensor (not illustrated) installed in the vehicle, for example. Also, it is determined whether a user looks at the display units 120 and 220 or the input devices 210 and 211 carefully by detection of a gaze of the user based on an image imaged by an imaging device (not illustrated).

Note that in each of the above described embodiments and modification examples, the display units 120 and 220 and the operation units 1110 and 2110 of the display devices 11 and 21 are tabular. However, this is not the limitation. For example, each of the display units 120 and 220, the operation unit 1110 and 2110, and the switch 2140 of the display devices 11 and 21 may have a shape including a curved surface. Here, for example, tactile perception given to the user may be changed according to shapes of the operation units 1110 and 2110 and the switch 2140. That is, the vibration control units 1145 and 2165 may change a vibration state of the vibration units 1130 and 2130 according to shapes of the operation units 1110 and 2110 and the switch 2140 and the contact positions C1 and C2 of the user.

For example, when the contact positions C1 and C2 move in a direction of getting far from a peak, that is, move from the maximum value to the minimum value of the curved surface, the vibration control units 1145 and 2165 control the vibration units 1130 and 2130 in such a manner that a vibration state becomes a first vibration state. Accordingly, friction force on the operation surfaces 1120A and 2120A is decreased and it is possible to make the fingers U11 and U2 of the user move smoothly.

Alternatively, for example, when the contact positions C1 and C2 move in a direction of getting closer to a peak, that is, move from the minimum value to the maximum value of the curved surface, the vibration control units 1145 and 2165 control the vibration units 1130 and 2130 in such a manner that a vibration state becomes a second vibration state. Accordingly, friction force on the operation surfaces 1120A and 2120A is increased and it becomes difficult for the fingers U11 and U2 of the user to move smoothly. Note that the above-described vibration states are examples. For example, friction force on operation surfaces 1120A and 2120A may be increased when contact positions C1 and C2 get farther from a user and friction force may be decreased when the positions get closer thereto.

Hardware Configuration

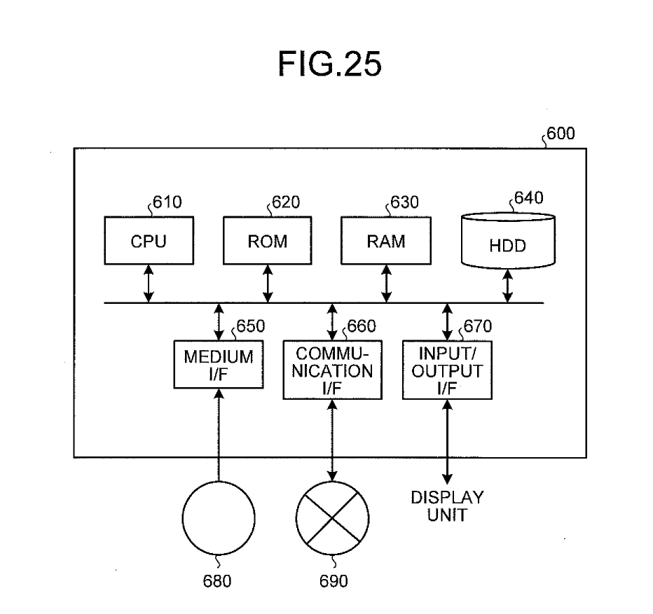

The display devices 11 to 13, and 21 according to the above embodiments and modification examples can be realized by a computer 600 having a configuration illustrated as an example in FIG. 25. Note that in the following, an example of a computer that realizes a function of the display device 11 will be described. Since the display devices 12, 13, and 21 are in a similar manner, a description thereof is omitted. FIG. 25 is a hardware configuration view illustrating an example of a computer that realizes a function of the display device 11.

The computer 600 includes a central processing unit (CPU) 610, a read only memory (ROM) 620, a random access memory (RAM) 630, and a hard disk drive (HDD) 640. Also, the computer 600 includes a medium interface (I/F) 650, a communication interface (I/F) 660, and an input/output interface (I/F) 670.

Note that the computer 600 includes a solid state drive (SSD) and the SSD may execute a part or all of a function of the HDD 640. Also, an SSD may be provided instead of the HDD 640.

The CPU 610 operates based on a program stored in at least one of the ROM 620 and the HDD 640 and controls each unit. The ROM 620 stores a boot program executed by the CPU 610 in activation of the computer 600, a program depending on hardware of the computer 600, and the like. The HDD 640 stores a program executed by the CPU 610 and data or the like used by the program.

The medium I/F 650 reads a program or data stored in a storage medium 680 and provides the program or data to the CPU 610 through the RAM 630. The CPU 610 loads the program on the RAM 630 from the storage medium 680 through the medium I/F 650 and executes the loaded program. Alternatively, the CPU 610 executes the program by using the data. The storage medium 680 is, for example, a magnetooptical medium such as a digital versatile disc (DVD), an SD card, or a USB memory.

The communication I/F 660 receives data from a different device through a network 690, transmits the data to the CPU 610, and transmits data generated by the CPU 610 to a different device through the network 690. Alternatively, the communication I/F 660 receives a program from a different device through the network 690 and transmits the program to the CPU 610. The CPU 610 executes the program.

The CPU 610 controls a display unit 20 such as a display, an output unit such as a speaker, and an input unit such as a keyboard, a mouse, a button, or an operation unit 1110 through the input/output I/F 670. The CPU 610 acquires data from the input unit through the input/output I/F 670. Also, the CPU 610 outputs generated data to a display unit 20 or the output unit through the input/output I/F 670.

For example, when the computer 600 functions as the display device 11, the CPU 610 of the computer 600 realizes functions of a control unit 1140 of an input device 110 which unit includes a detection unit 1141, a locus setting unit 1142, a locus determination unit 1143, a comparison unit 1144, and a vibration control unit 1145 and a display control unit 130 by executing the program loaded on the RAM 630.

For example, the CPU 610 of the computer 600 reads these programs from the storage medium 680 and executes the programs. In a different example, these programs may be acquired from a different device through the network 690. Also, the HDD 640 stores information stored in the storage unit 140.

As described above, an input device 10 included in a display device 1 according to an embodiment includes a detection unit 141, at least one vibration element 130a or 130b, and a vibration control unit 145. The detection unit 141 detects a contact position C of a user on an operation surface 120A. The vibration element 130a or 130b vibrates the operation surface 120A. The vibration control unit 145 controls the vibration element 130a or 130b in such a manner that a vibration state of the vibration element 130a or 130b becomes a first vibration state when the contact position C detected by the detection unit 141 moves along a predetermined leading locus TA and that a vibration state of the vibration element 130a or 130b becomes a second vibration state different from the first vibration state when the contact position C moves in a manner deviated from the leading locus TA.

Accordingly, for example, smooth tactile perception can be given to a finger U1 of the user when the contact position C of the user on the operation surface 120A moves along the leading locus TA, and unsmooth tactile perception can be given when the movement is in a manner deviated from the leading locus TA. Thus, it becomes easy for the user to move the finger U1 along the leading locus TA and it is possible to improve operability of the user with respect to the input device 10.

Also, an input device 10 according to an embodiment further includes a locus determination unit 143 and a comparison unit 144. The locus determination unit 143 determines a movement locus of a contact position C according to the contact position C detected by a detection unit 141. The comparison unit 144 compares the movement locus determined by the locus determination unit 143 with a leading locus TA. Also, according to a result of the comparison performed by the comparison unit 144, a vibration control unit 145 changes a vibration state of a vibration element 130a or 130b into a first vibration state when the movement locus is along the leading locus TA and changes a vibration state of the vibration element 130a or 130b into a second vibration state when the movement locus deviates from the leading locus TA.

Accordingly, for example, it is possible to give smooth tactile perception or unsmooth tactile perception to a finger U1 of a user according to the movement locus of the contact position C of the user. Thus, it becomes easy for the user to move the finger U1 along the leading locus TA and it is possible to improve operability of the user with respect to the input device 10.

Also, an input device 10 according to an embodiment includes a locus setting unit 142 to set a leading locus TA corresponding to predetermined input operation performed by a user. Accordingly, it becomes easy for the user to perform the predetermined input operation along the leading locus TA and it is possible to improve operability of the user.

Also, a locus setting unit 142 of an input device 10 according to an embodiment sets a leading locus TA based on a contact position C detected by a detection unit 141. Accordingly, the locus setting unit 142 can dynamically set a leading locus TA according to a contact position C and it becomes easy for a user to perform predetermined input operation along the leading locus TA. Thus, it is possible to improve operability of the user.

Also, a locus setting unit 142 of an input device 10 according to an embodiment sets a leading locus TA from a contact position C detected by a detection unit 141 to a predetermined position corresponding to input operation. Accordingly, it becomes easy for a user to move the contact position C to the predetermined position and it is possible to improve operability of the user.

Also, a locus setting unit 142 of an input device 10 according to an embodiment sets a leading locus TA according to an object to be displayed on a display unit 20 on which an image corresponding to operation performed by a user on an operation surface 120A is displayed. Accordingly, it becomes possible for the user to perform input operation along a leading locus TA corresponding to an object to be displayed and it is possible to improve operability of the user.

Also, a locus setting unit 142 of an input device 10 according to an embodiment sets a leading locus TA according to at least one of the number, an arrangement, and a size of objects to be displayed. Accordingly, it becomes possible for a user to perform input operation along a leading locus TA corresponding to the number, an arrangement, and a size of objects to be displayed and it is possible to improve operability of the user.

Also, an input device 11 according to an embodiment includes a speed calculation unit 146 to calculate a moving speed V of a contact position C according to a temporal change in the contact position C detected by a detection unit 141. Also, a vibration control unit 145 changes a vibration state of a vibration element 130a or 130b according to the moving speed V calculated by the speed calculation unit 146. Accordingly, it is possible to give a user tactile perception corresponding to a moving speed of a contact position C and to improve operability of the user.

An input device 12 according to an embodiment includes an operation estimating unit 147 that estimates input operation by a user according to a movement locus of a contact position C detected by a detection unit 141. When the operation estimating unit 147 estimates input operation, a vibration control unit 145 controls a vibration element 130a or 130b into a vibration state different from a first vibration state. Accordingly, the input device 12 can notify a user that input operation is estimated. Thus, for example, it becomes unnecessary for the user to keep performing input operation after the estimation by the input device 12. Thus, it is possible to improve operability of the user.

Display devices 1 to 3 according to embodiments respectively include input devices 10 to 12 that are the above-described input devices 10 to 12 and that receive input operation from a user and display units 20 to display an image according to the input operation received by the input devices 10 to 12. Since the input devices 10 to 12 that can improve operability of a user are included, it is possible to improve operability of the display devices 1 to 3.

Each of input devices 210 and 211 according to an embodiment and a modification example includes a detection unit 2161, a switch detection unit 2163, at least one vibration element 2130, and a vibration control unit 2165. The detection unit 2161 detects a contact position C2 of a user on an operation surface 2120A. The switch detection unit 2163 detects pressing operation of a user on a pressed surface 2150 arranged on the same flat surface with an operation surface 2120A in a manner adjacent to the operation surface 2120A. The vibration element 2130 vibrates the operation surface 2120A. Based on a result of the detection by the detection unit 2161, the vibration control unit 2165 controls the vibration element 2130 into a first vibration state when the contact position C2 moves on the operation surface 2120A and into a second vibration state different from the first vibration state when the contact position C2 moves between the operation surface 2120A and the pressed surface 2150.

Accordingly, it is possible to arrange the pressed surface 2150 on the same flat surface with the operation surface 2120A and it becomes possible for a user to recognize a boundary of the operation surface 2120A and the pressed surface 2150. Thus, a degree of freedom in designability of the input devices 210 and 211 can be improved. Also, it becomes easy for the user to recognize a pressed surface 2150 of a switch 2140 and it is possible to improve convenience in input operation by the user. In such a manner, the operation surface 2120A and the pressed surface 2150 are arranged on the same flat surface to improve a degree of freedom in designability and a movement between the operation surface 2120A and the pressed surface 2150 on the same flat surface is notified with vibration and a step, whereby it is possible to perform a movement between the operation surface 2120A and the pressed surface 2150, for example, by eyes-free operation performed without looking at a hand and to improve operability with respect to the input device 210.

Also, each of input devices 210 and 211 according to an embodiment and a modification example further includes a movement determination unit 2162 that determines that a contact position C2 moved between an operation surface 2120A and a pressed surface 2150 based on a result of detection by a detection unit 2161 when the contact position C2 moves in an adjacent region D21 that is an outer periphery region of the operation surface 2120A and that is adjacent to the pressed surface 2150. Also, a vibration control unit 2165 controls a vibration element 2130 based on a result of the determination by the movement determination unit 2162.

Accordingly, it becomes possible for a user to recognize the adjacent region D21 that is a boundary of the operation surface 2120A and the pressed surface 2150. Thus, it becomes easy for the user to recognize the boundary and it is possible to improve convenience in input operation by the user.

Also, a vibration element 2130 of each of input devices 210 and 211 of an embodiment and a modification example vibrates a pressed surface 2150. Also, a vibration control unit 2165 changes a vibration state of the vibration element 2130 according to a result of detection by a switch detection unit 2163.

Accordingly, it becomes easy for a user to recognize a pressed surface 2150 of a switch 2140 and it is possible to improve convenience in input operation by the user.

Also, an input device 211 according to a modification example of an embodiment further includes a step 2200 formed between an operation surface 2120A and a pressed surface 2150.

Accordingly, it becomes easy for a user to recognize a boundary of the operation surface 2120A and the pressed surface 2150 even when the step 2200 is low. Thus, it is possible to form the low step 2200, to improve a degree of freedom in designability, and to improve convenience in input operation performed by the user.

Also, an input device 211 according to a modification example of an embodiment includes a region determination unit 2166 that determines, based on a result of detection by a detection unit 2161, whether a contact position C2 moves in a first region of an operation surface 2120A, moves in a second region adjacent to the first region of the operation surface 2120A, or moves between the first and second regions. Also, based on a result of the determination by the region determination unit 2166, a vibration control unit 2165 controls a vibration element 2130 into a first vibration state when the contact position C2 moves in the first or second region and into a second vibration state when the contact position C2 moves between the first and second regions.

Accordingly, it is possible to divide the operation surface 2120A of the input device 211 into a plurality of divided regions corresponding to the first and second regions and to receive input operation on each of the divided regions, whereby it is possible to improve convenience in input operation by a user. Also, since a change in friction force is used to make the user recognize a boundary of the plurality of divided regions, it is not necessary to provide a physical boundary on the operation surface 2120A. Thus, it is possible to improve a degree of freedom in designability.

Also, an input device 211 according to a modification example of an embodiment includes a second display unit 2190 that displays an object to be displayed for a user through an operation surface 2120A and a second display control unit 2167 that displays objects to be displayed, which objects correspond to first and second regions, on the second display unit 2190 based on a result of determination by a region determination unit 2166.

Accordingly, since it also becomes possible to present divided regions corresponding to the first and second regions with visual information, it is possible to improve convenience in input operation by the user.

Also, display devices 21 and 22 according to an embodiment and the present modification example respectively include input devices 210 and 211 that receive input operation from a user and a display unit 220 that is arranged in a place different from an operation surface 2120A and that displays images corresponding to the input devices 210 and 211 according to a contact position C2.

Accordingly, for example, it is possible to arrange the display unit 220 at a position where the user can visually recognize easily and to arrange the input devices 210 and 211 at positions where the user can easily perform operation, whereby it is possible to improve convenience of the user.

Also, each of display devices 21 and 22 according to an embodiment and the present modification example includes a display control unit 230 that displays an image corresponding to a switch detection unit 2163 onto a display unit 220 based on a result of detection by a detection unit 2161 when a contact position C2 moves from an operation surface 2120A to a pressed surface 2150.

Accordingly, it becomes easy for a user to perform input operation while visually recognizing the display unit 220 and it is possible to improve convenience of the user.

A further effect or modification example can be easily led by those skilled in the art. Thus, a wider mode of the present invention is not limited to a specific detail and representative embodiments expressed and described in the above. Thus, it is possible to make various modifications within the spirit and the scope of a general concept of the invention defined by attached claims and an equivalent thereof.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An input device comprising:
a detection unit configured to detect a contact position of a user on an operation surface;
at least one vibration element configured to vibrate the operation surface; and
a vibration control unit configured to control the vibration element in such a manner that a vibration state of the vibration element becomes a first vibration state when the contact position detected by the detection unit is in a predetermined region and that the vibration state of the vibration element becomes a second vibration state different from the first vibration state when the contact position is outside the predetermined region.

2. The input device according to claim 1, wherein the vibration control unit controls the vibration element in such a manner that the vibration state of the vibration element becomes the first vibration state when the contact position moves along a predetermined leading locus in the predetermined region and that the vibration state of the vibration element becomes the second vibration state when the contact position moves in a manner deviated from the leading locus.

3. The input device according to claim 2, further comprising a locus determination unit configured to determine a movement locus of the contact position according to the contact position detected by the detection unit, and
a comparison unit configured to compare the movement locus determined by the locus determination unit and the leading locus,
wherein according to a result of the comparison by the comparison unit, the vibration control unit changes the vibration state of the vibration element into the first vibration state when the movement locus is along the leading locus, and changes the vibration state of the vibration element into the second vibration state when the movement locus is deviated from the leading locus.

4. The input device according to claim 2, further comprising a locus setting unit configured to set a leading locus corresponding to predetermined input operation performed by the user.

5. The input device according to claim 4, wherein the locus setting unit sets the leading locus based on the contact position detected by the detection unit.

6. The input device according to claim 5, wherein the locus setting unit sets a leading locus from the contact position detected by the detection unit to a predetermined position corresponding to the input operation.

7. The input device according to claim 4, wherein the locus setting unit sets a leading locus according to an object to be displayed on an display unit on which an image corresponding to operation by the user on the operation surface is displayed.

8. The input device according to claim 7, wherein the locus setting unit sets a leading locus according to at least one of the number, an arrangement, and a size of objects to be displayed.

9. The input device according to claim 2, further comprising a speed calculation unit configured to calculate a moving speed of the contact position according to a temporal change of the contact position detected by the detection unit,
wherein the vibration control unit changes the vibration state of the vibration element according to the moving speed calculated by the speed calculation unit.

10. The input device according to claim 2, further comprising an operation estimating unit configured to estimate input operation by the user according to a movement locus of the contact position detected by the detection unit,
wherein the vibration control unit controls the vibration element into a vibration state different from the first vibration state when the operation estimating unit estimates the input operation.

11. The input device according to claim 1, further comprising a switch unit configured to detect pressing operation by the user on a pressed surface that is arranged on a surface continuous to the operation surface in a manner adjacent to the operation surface,
wherein the vibration control unit controls the vibration element into the first vibration state in a case where the contact position moves on the operation surface in the predetermined region and into the second vibration state in a case where the contact position moves in a region between the operation surface and the pressed surface which region is outside the predetermined region.

12. The input device according to claim 11, further comprising a movement determination unit configured to determine, based on a result of the detection by the detection unit, that the contact position moves between the operation surface and the pressed surface when the contact position moves in an adjacent region that is an outer periphery region in the operation surface and that is adjacent to the pressed surface,
wherein the vibration control unit controls the vibration element based on a result of the determination by the movement determination unit.

13. The input device according to claim 11, wherein the vibration element vibrates the pressed surface, and
the vibration control unit changes the vibration state of the vibration element according to a result of the detection by the switch unit.

14. The input device according to claim 11, further comprising a step formed between the operation surface and the pressed surface.

15. The input device according to claim 11, further comprising a region determination unit configured to determine, based on a result of the detection by the detection unit, whether the contact position moves in a first region of the operation surface, in a second region adjacent to the first region of the operation surface, or between the first and second regions,
wherein the vibration control unit controls the vibration element, based on a result of the determination by the region determination unit, into the first vibration state in a case where the contact position moves in the first or second region and into the second vibration state in a case where the contact position moves between the first and second regions.

16. The input device according to claim 15, further comprising a display unit configured to display an object to be displayed for the user through the operation surface, and
a display control unit configured to display objects to be displayed, which objects correspond to the first and second regions, on the display unit based on a result of the determination by the region determination unit.

17. A display device comprising:
the input device according to claim 1, which device is configured to receive input operation from a user, and
a display unit configured to display an image, which corresponds to the input device, according to a contact position.

18. The display device according to claim 17, wherein the display unit is arranged at a place different from the operation surface.

19. A method of controlling an input device, comprising:
detecting a contact position of a user on an operation surface;
vibrating the operation surface with at least one vibration element; and
controlling the vibration element in such a manner that a vibration state of the vibration element becomes a first vibration state in a case where the contact position is in a predetermined region and that the vibration state of the vibration element becomes a second vibration state different from the first vibration state in a case where the contact position is outside the predetermined region.

20. A non-transitory computer readable storage medium having stored therein a program, causing a computer to execute a process comprising:
detecting a contact position of a user on an operation surface;
vibrating the operation surface with at least one vibration element; and
controlling the vibration element in such a manner that a vibration state of the vibration element becomes a first vibration state in a case where the contact position is in a predetermined region and that the vibration state of the vibration element becomes a second vibration state different from the first vibration state in a case where the contact position is outside the predetermined region.
